(19) United States
(12) Patent Application Publication
(10) Pub. No.: US 2026/0307507 A1
(43) Pub. Date: Oct. 8, 2026

(54) DRIVE CONTROL APPARATUS

(71) Applicant: Mitsubishi Electric Corporation, Chiyoda-ku, Tokyo (JP)

(72) Inventor: Ryo YANAGISAWA, Chiyoda-ku, Tokyo (JP)

(73) Assignee: Mitsubishi Electric Corporation, Chiyoda-ku, Tokyo (JP)

(21) Appl. No.: 19/100,884

(22) PCT Filed: Nov. 2, 2022
(86) PCT No.: PCT/JP2022/041078

§ 371 Date: Feb. 3, 2025

(51) Int. Cl. B60L 50/13

(52) U.S. Cl. CPC B60L 50/13; B60L 2200/26; B60L 2210/30; B60L 2210/40; B60L 2240/44; B60L 2240/526

(57) ABSTRACT

When only part of internal combustion engines is started, in a drive control apparatus, one first inverter, of the first inverters, connected via a power generator and a converter to an unstarted internal combustion engine, of the internal combustion engines, converts AC power received from another first inverter, of the first inverters, connected via the power generator and the converter to the started internal combustion engine, into DC power, and supplies the DC power resulting from the conversion to at least one of the converter or the power storage device.

### TECHNICAL FIELD

The present disclosure relates to a drive control apparatus.

### BACKGROUND ART

Some railway vehicles use an internal combustion engine as a power source. Patent Literature 1 discloses an example of such kind of railway vehicle. The railway vehicle disclosed in Patent Literature 1 includes an engine, a power generator to be driven by the engine to generate alternating-current (AC) power, a converter to convert the AC power generated by the power generator into direct-current (DC) power and output the resulting DC power, an inverter to convert the DC power output by the converter into AC power and output the resulting AC power, an electric motor to rotate in response to feeding of the AC power from the inverter, and a drive control apparatus to control the converter and the inverter.

### CITATION LIST

### Patent Literature

Patent Literature 1: International Publication No. WO 2019/073822

### SUMMARY OF INVENTION

### Technical Problem

To start the engine, power is to be supplied to the power generator, the power generator is to operate as an electric motor, and a rotational force is to be transmitted to the engine from the power generator that operates as an electric motor. To supply power to the power generator, a power storage device capable of storing power needed at a start of the engine is provided. The power generator operates as the electric motor and rotates by the converter converting the DC power supplied from the power storage device into AC power and supplying the resulting AC power to the power generator. The rotation of the power generator starts the engine.

When the engine is stopped, the power storage device may be electrically connected to other electronic devices, for example, due to mishandling during maintenance operation, which may cause the power storage device to discharge. As a result, the engine becomes unable to be started the next time the railway vehicle starts running. At this time, in order to start the engine with the power supplied by the power storage device, complicated processes such as removing the power storage device from the railway vehicle, charging the power storage device at an aboveground charging facility to a level at which the engine is startable, and re-assembling the power storage device into the railway vehicle are necessary.

In view of the above circumstances, an objective of the present disclosure is to provide a drive control apparatus that can readily achieve charging of a power storage device.

### Solution to Problem

To achieve the aforementioned objective, the drive control apparatus of the present disclosure is a drive control apparatus for controlling driving of a railway vehicle that uses internal combustion engines as a power source. The drive control apparatus includes converters capable of performing bidirectional power conversion between AC power and DC power, first inverters capable of performing bidirectional power conversion between DC power and AC power, and power storage devices. The converters are provided for respective power generators. The power generators are provided for the respective internal combustion engines and are driven by the respective internal combustion engines to generate AC power. The first inverters are provided for the respective converters, and each have primary terminals and secondary terminals. The primary terminals are connected to the converter, and the secondary terminals are connected to a load device. The load device operates with AC power. The power storage devices are provided for the respective converters, and are each connected to the corresponding converter and the primary terminals of the corresponding first inverter. Each power storage device is charged with DC power output by the converter or the first inverter, and stores power for starting the internal combustion engine. The secondary terminals of the first inverters are connected to each other. At a start of the internal combustion engines, each of the converters converts DC power into AC power, and supplies the AC power resulting from the conversion to the power generator. When only part of the internal combustion engines is started, one first inverter, of the first inverters, connected via the power generator and the converter to an unstarted internal combustion engine, of the internal combustion engines, receives AC power from another first inverter, of the first inverters, connected via the converter to the power generator driven by the started internal combustion engine, converts the received AC power into DC power, and supplies the DC power resulting from the conversion to at least one of the converter or the power storage device.

### Advantageous Effects of Invention

According to the drive control apparatus of the present disclosure, when only part of the internal combustion engines is started, one first inverter, of the first inverters, connected via the power generator and the converter to an unstarted internal combustion engine, of the internal combustion engines, converts the AC power supplied from another first inverter, of the first inverters, connected via the power generator and the converter to the started internal combustion engine, into DC power, and supplies the DC power resulting from the conversion to at least one of the converter or the power storage device. When the DC power is supplied from the first inverter to the power storage device, the power storage device can be charged. The converter converts the DC power supplied from the charged power storage device into AC power, and supplies the AC power resulting from the conversion to the power generator. This allows the internal combustion engine to be started. When the DC power is supplied from the first inverter to the converter, the converter converts the DC power supplied from the first inverter into AC power, and supplies the AC power resulting from the conversion to the power generator. This allows the internal combustion engine to be started. When the AC power generated by the power generator driven by the started internal combustion engine is converted into DC power by the converter, and the DC power resulting from the conversion is supplied to the power storage device, the power storage device can be charged. That is, according to the drive control apparatus of the present disclosure, a drive control apparatus that facilitates charging of the power storage devices is obtained as removing, from the railway vehicle, the power storage device for charging at the charging facility is unnecessary.

### BRIEF DESCRIPTION OF DRAWINGS

FIG. 1 is a block diagram illustrating a configuration of a drive control apparatus according to Embodiment 1;

FIG. 2 is a block diagram illustrating a configuration of a first inverter according to Embodiment 1;

FIG. 3 is a block diagram illustrating a configuration of a controller according to Embodiment 1;

FIG. 4 is a block diagram illustrating a hardware configuration of the controller according to Embodiment 1;

FIG. 5 is a timing chart illustrating an example of operations of starting internal combustion engines and charging power storage devices that are performed by the drive control apparatus according to Embodiment 1, in a state in which each power storage device is charged;

FIG. 6 is a timing chart illustrating an example of operations of starting the internal combustion engines and charging the power storage devices that are performed by the drive control apparatus according to Embodiment 1, in a state in which part of the power storage devices is discharged;

FIG. 7 is a diagram illustrating an example of current flows in the drive control apparatus according to Embodiment 1;

FIG. 8 is a timing chart illustrating an example of operations of starting internal combustion engines and charging power storage devices that are performed by a drive control apparatus according to Embodiment 2, in a state in which part of power storage devices is discharged;

FIG. 9 is a diagram illustrating an example of current flows in the drive control apparatus according to Embodiment 2;

FIG. 10 is a block diagram illustrating a configuration of a first modified example of a drive control apparatus according to an embodiment;

FIG. 11 is a timing chart illustrating another example of operations of starting internal combustion engines and charging power storage devices that are performed by a drive control apparatus according to the embodiment, in a state in which part of the power storage devices is discharged;

FIG. 12 is a block diagram illustrating a configuration of a second modified example of a drive control apparatus according to an embodiment;

FIG. 13 is a diagram illustrating an example of current flows in the second modified example of the drive control apparatus according to the embodiment;

FIG. 14 is a diagram illustrating another example of current flows in the second modified example of the drive control apparatus according to the embodiment; and

FIG. 15 is a block diagram illustrating a modified example of a hardware configuration of a controller according to an embodiment.

### DESCRIPTION OF EMBODIMENTS

A drive control apparatus according to embodiments of the present disclosure is described below in detail with reference to the drawings. Components identical or corresponding to each other are provided with the same reference sign in the drawings.

### Embodiment 1

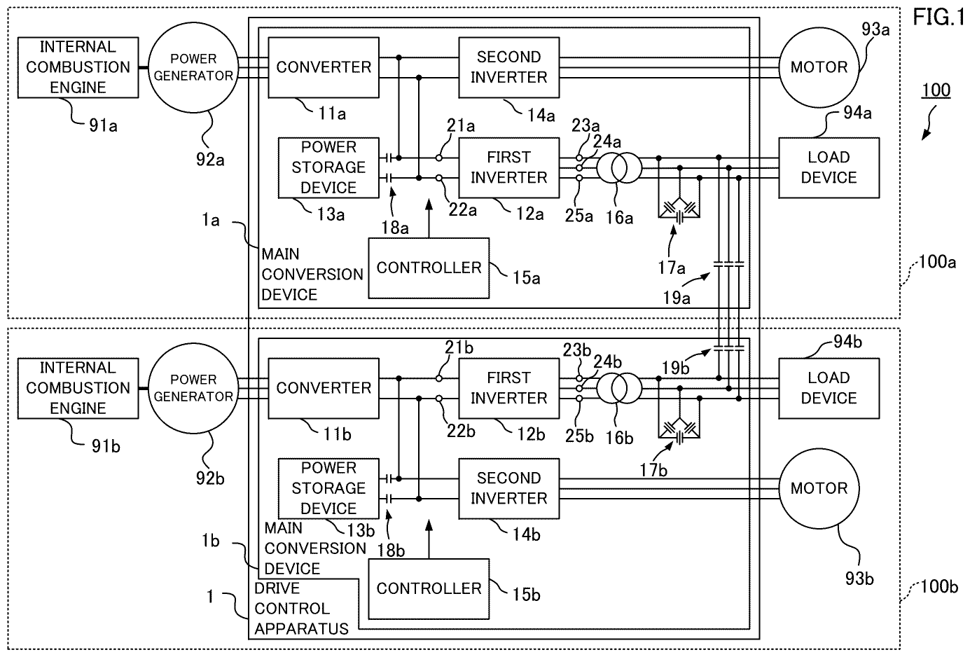

A drive control apparatus for controlling driving of a railway vehicle is described using a railway vehicle that uses a plurality of internal combustion engines as a power source as an example. A railway vehicle driving apparatus 100 is illustrated in FIG. 1. The railway vehicle driving apparatus 100 drives a railway vehicle including a plurality of vehicles 100a, 100b.

The railway vehicle driving apparatus 100 includes internal combustion engines 91a, 91b that are a power source, power generators 92a, 92b driven by the internal combustion engines 91a, 91b to generate AC power, and a drive control apparatus 1 for controlling driving of a railway vehicle by supplying the power generated by the power generators 92a, 92b to main motors 93a, 93b. The railway vehicle driving apparatus 100 includes the main motors 93a, 93b to receive the AC power from the drive control apparatus 1 and rotate to generate propulsion of the railway vehicle, and load devices 94a, 94b to operate with power from the drive control apparatus 1.

The drive control apparatus 1 includes a main conversion device 1a and a main conversion device 1b. The main conversion device 1a converts AC power supplied from the power generator 92a into AC power suitable for each of the main motor 93a and the load device 94a, and supplies the resulting AC power to the main motor 93a and the load device 94a. The main conversion device 1b converts AC power supplied from the power generator 92b into AC power suitable for each of the main motor 93b and the load device 94b, and supplies the resulting AC power to the main motor 93b and the load device 94b.

The internal combustion engine 91a, the power generator 92a, the main conversion device 1a, the main motor 93a, and the load device 94a are installed in the vehicle 100a. The internal combustion engine 91b, the power generator 92b, the main conversion device 1b, the main motor 93b, and the load device 94b are installed in the vehicle 100b.

The internal combustion engines 91a, 91b are a diesel engine, a gasoline engine, or the like. Output shafts of the internal combustion engines 91a, 91b are fixed to shafts of the power generators 92a, 92b, respectively. As a result, at the start of running of the railway vehicle, the power generators 92a, 92b operating as electric motors and rotating enables the internal combustion engines 91a, 91b to be started. After the start of the internal combustion engines 91a, 91b, as the internal combustion engines 91a, 91b rotate, the power generators 92a, 92b rotate to generate AC power. The engine speed of the internal combustion engines 91a, 91b is controlled by an internal-combustion-engine controller, which is not illustrated.

The internal-combustion-engine controller acquires a start command signal, an operation command signal, and the engine speeds of the internal combustion engines 91a, 91b measured by speed sensors, which are not illustrated. The start command signal varies depending on manipulation of a starting switch provided in a driver cab. The operation command signal varies depending on manipulation of a master controller provided in the driver cab. The internal-combustion-engine controller determines, based on the start command signal, the operation command signal, and measured values of the engine speeds of the internal combustion engines 91a, 91b, target engine speeds and controls the engine speeds of the internal combustion engines 91a, 91b to be closer to the target engine speeds.

When the internal combustion engines 91a, 91b are not started, the power generators 92a, 92b each operate as an electric motor and rotate upon receiving AC power from the drive control apparatus 1. After the start of the internal combustion engines 91a, 91b, the power generators 92a, 92b are driven by the respective internal combustion engines 91a, 91b to generate AC power, and supply the generated AC power to the drive control apparatus 1. The power generators 92a, 92b are, for example, an induction generator.

The main motors 93a, 93b are each driven by receiving the AC power from the drive control apparatus 1 to generate propulsion of the railway vehicle. For simplicity of illustration, the main motors 93a, 93b are each illustrated as one in FIG. 1, but a plurality of main motors is installed in each vehicle. More specifically, a plurality of main motors 93a, for example, four main motors 93a are installed in the vehicle 100a. A plurality of main motors 93b, for example, four main motors 93b are installed in the vehicle 100b. The main motors 93a, 93b are, for example, three-phase induction motors.

The load devices 94a, 94b each operate with the AC power from the drive control apparatus 1. The load devices 94a, 94b are, for example, in-vehicle devices such as lighting equipment, air-conditioners, and the like.

The drive control apparatus 1 includes a plurality of converters 11a, 11b, and a plurality of first inverters 12a, 12b. The converters 11a, 11b are respectively connected to the power generators 92a, 92b provided to the respective internal combustion engines 91a, 91b, and are capable of performing bidirectional power conversion between AC power and DC power. The first inverters 12a, 12b are respectively connected to the converters 11a, 11b, and are capable of performing bidirectional power conversion between DC power and AC power. The drive control apparatus 1 includes a plurality of power storage devices 13a, 13b connected to the respective converters 11a, 11b and the respective first inverters 12a, 12b. The drive control apparatus 1 further includes second inverters 14a, 14b respectively connected to the converters 11a, 11b. This connection means electrical connection of components.

Specifically, the main conversion device 1a included in the drive control apparatus 1 includes the converter 11a, the first inverter 12a, the second inverter 14a, and the power storage device 13a. The converter 11a converts the AC power supplied from the power generator 92a into DC power, and outputs the resulting DC power. The first inverter 12a converts the DC power supplied from the converter 11a into AC power, and outputs the resulting AC power to the load device 94a. The second inverter 14a converts the DC power supplied from the converter 11a into AC power, and supplies the resulting AC power to the main motor 93a. The power storage device 13a is connected to the converter 11a, the first inverter 12a, and the second inverter 14a.

The main conversion device 1a includes a transformer 16a and an AC capacitor 17a. The transformer 16a has primary terminals connected to the first inverter 12a. The transformer 16a transforms the AC power output by the first inverter 12a to allow the AC power output by the first inverter 12a to be suitable for the load device 94a. The AC capacitor 17a is connected to secondary terminals of the transformer 16a.

The main conversion device 1a includes power-storage-device contactors 18a and inverter contactors 19a. The power-storage-device contactors 18a switch electrical connection between (i) the power storage device 13a and (ii) the converter 11a, the first inverter 12a, and the second inverter 14a. The inverter contactors 19a each have an end connecting to a point of connection between the AC capacitor 17a and the load device 94a.

The main conversion device 1a includes a controller 15a to control the converter 11a, the first inverter 12a, the second inverter 14a, the power-storage-device contactors 18a, and the inverter contactors 19a.

Similarly, the main conversion device 1b included in the drive control apparatus 1 includes the converter 11b, the first inverter 12b, the second inverter 14b, and the power storage device 13b. The converter 11b converts the AC power supplied from the power generator 92b into DC power, and outputs the resulting DC power. The first inverter 12b converts the DC power supplied from the converter 11b into AC power, and outputs the resulting AC power to the load device 94b. The second inverter 14b converts the DC power supplied from the converter 11b into AC power, and supplies the resulting AC power to the main motor 93b. The power storage device 13b is connected to the converter 11b, the first inverter 12b, and the second inverter 14b.

The main conversion device 1b includes a transformer 16b and an AC capacitor 17b. The transformer 16b has primary terminals connected to the first inverter 12b. The transformer 16b transforms the AC power output by the first inverter 12b to allow the AC power output by the first inverter 12b to be suitable for the load device 94b. The AC capacitor 17b is connected to secondary terminals of the transformer 16b.

The main conversion device 1b includes power-storage-device contactors 18b and inverter contactors 19b. The power-storage-device contactors 18b switch electrical connection between (i) the power storage device 13b and (ii) the converter 11b, the first inverter 12b, and the second inverter 14b. The inverter contactors 19b each have an end connecting to a point of connection between the AC capacitor 17b and the load device 94b.

The main conversion device 1b includes a controller 15b to control the converter 11b, the first inverter 12b, the second inverter 14b, the power-storage-device contactors 18b, and the inverter contactors 19b.

For example, when the railway vehicle parked in a train depot starts running, the drive control apparatus 1 having the aforementioned configuration starts the internal combustion engines 91a, 91b. Specifically, the drive control apparatus 1 causes the converters 11a, 11b to convert the DC power stored in the power storage devices 13a, 13b into AC power, and supplies the resulting AC power to the power generators 92a, 92b to cause the power generators 92a, 92b to operate as electric motors and rotate. This causes rotation of the internal combustion engines 91a, 91b having the output shafts to which the shafts of the power generators 92a, 92b are fixed, to start the internal combustion engines 91a, 91b.

When one of the power storage devices 13a, 13b is discharged, AC power cannot be supplied to a corresponding one of the power generators 92a, 92b, and therefore, a corresponding one of the internal combustion engines 91a, 91b cannot be started. At this time, the drive control apparatus 1 charges both of the power storage devices 13a, 13b using the power generated by the power generator 92a or the power generator 92b driven by the other of the internal combustion engines 91a, 91b started. In doing so, the drive control apparatus 1 that facilitates charging of the power storage devices 13a, 13b is obtained as removing, from the railway vehicle, the one of the power storage devices 13a, 13b discharged for charging at the charging facility is unnecessary.

The configuration of the drive control apparatus 1 having the aforementioned configuration is described in detail below. The converter 11a is connected to the power generator 92a driven by the internal combustion engine 91a. The converter 11b is connected to the power generator 92b driven by the internal combustion engine 91b. Specifically, the converter 11a has AC-side terminals connected to output terminals of the power generator 92a, and has DC-side terminals connected to the first inverter 12a, the power storage device 13a, and the second inverter 14a. The converter 11b has AC-side terminals connected to output terminals of the power generator 92b, and has DC-side terminals connected to the first inverter 12b, the power storage device 13b, and the second inverter 14b.

Each of the converters 11a, 11b includes a capacitor and a plurality of switching elements. The capacitors are charged with DC power supplied from the corresponding power storage devices 13a, 13b at the start of the internal combustion engines 91a, 91b. The switching elements are connected in parallel to the capacitor. The switching elements of the converters 11a, 11b are controlled by the controllers 15a, 15b, allowing the converters 11a, 11b to convert AC power into DC power or convert DC power into AC power.

Specifically, upon receiving AC power from the connected power generators 92a, 92b, the converters 11a, 11b convert the AC power into DC power, and output the resulting DC power. More specifically, the converter 11a converts the AC power supplied from the power generator 92a into DC power, and supplies the resulting DC power to the first inverter 12a, the power storage device 13a, and the second inverter 14a. Similarly, the converter 11b converts the AC power supplied from the power generator 92b into DC power, and supplies the resulting DC power to the first inverter 12b, the power storage device 13b, and the second inverter 14b.

Upon receiving DC power, the converters 11a, 11b convert the DC power into AC power, and supply the resulting AC power to the connected power generators 92a, 92b. For example, at the start of the internal combustion engine 91a, the converter 11 a converts the DC power supplied from the power storage device 13a into AC power, and supplies the resulting AC power to the power generator 92a. As a result, the power generator 92a operating as an electric motor and rotating enables the internal combustion engine 91a to be started. Similarly, at the start of the internal combustion engine 91b, the converter 11b converts DC power supplied from the power storage device 13b into AC power, and supplies the resulting AC power to the power generator 92b. As a result, the power generator 92b operating as an electric motor and rotating enables the internal combustion engine 91b to be started.

The first inverters 12a, 12b are static converters, and maintain a constant output voltage and a constant output frequency. The first inverter 12a has primary terminals 21a, 22a that are DC-side terminals connected to the converter 11a, and secondary terminals 23a, 24a, 25a that are AC-side terminals connected to the load device 94a via the transformer 16a and the AC capacitor 17a. The first inverter 12b has primary terminals 21b, 22b that are DC-side terminals connected to the converter 11b, and secondary terminals 23b, 24b, 25b that are AC-side terminals connected to the load device 94b via the transformer 16b and the AC capacitor 17b. The secondary terminals 23a, 24a, 25a of the first inverter 12a are respectively connected to the secondary terminals 23b, 24b, 25b of the first inverter 12b via the inverter contactors 19a, 19b.

Upon receiving DC power from the converter 11a connected to the primary terminals 21a, 22a, the first inverter 12a converts the DC power into AC power, and supplies the resulting AC power to the load device 94a connected to the secondary terminals 23a, 24a, 25a. Similarly, upon receiving DC power from the converter 11b connected to the primary terminals 21b, 22b, the first inverter 12b converts the DC power into AC power, and supplies the resulting AC power to the load device 94b connected to the secondary terminals 23b, 24b, 25b.

When the internal combustion engine 91a has not been started and the first inverter 12a receives AC power from the first inverter 12b connected to the started internal combustion engine 91b via the power generator 92b and the converter 11b, the first inverter 12a converts the AC power into DC power, and supplies the resulting DC power to the converter 11a and the power storage device 13a.

Similarly, when the internal combustion engine 91b has not been started and the first inverter 12b receives AC power from the first inverter 12a connected to the started internal combustion engine 91a via the power generator 92a and the converter 11a, the first inverter 12b converts the AC power into DC power, and supplies the resulting DC power to the converter 11b and the power storage device 13b.

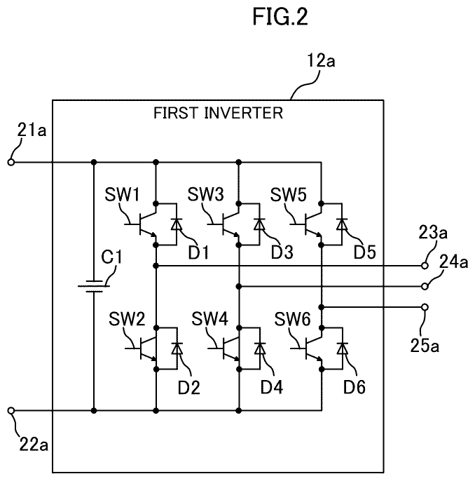

The first inverters 12a, 12b have the same structure. The details of the first inverter 12a are described. As illustrated in FIG. 2, the first inverter 12a includes a capacitor C1 of which both terminals are connected to the primary terminals 21a, 22a, switching elements SW1, SW2 provided between the primary terminals 21a, 22a and connected in series with each other, switching elements SW3, SW4 provided between the primary terminals 21a, 22a and connected in series with each other, and switching elements SW5, SW6 provided between the primary terminals 21a, 22a and connected in series with each other.

The switching elements SW1, SW2, the switching elements SW3, SW4, and the switching elements SW5, SW6 respectively correspond to a U phase, a V phase, and a W phase. The point of connection between the switching elements SW1, SW2 is connected to the secondary terminal 23a. The point of connection between the switching elements SW3, SW4 is connected to the secondary terminal 24a. The point of connection between the switching elements SW5, SW6 is connected to the secondary terminal 25a.

The switching elements SW1, SW2, SW3, SW4, SW5, SW6 are, for example, insulated-gate bipolar transistors (IGBTs), gate turn-off (GTO) thyristors, metal-oxide-semiconductor field-effect transistors (MOSFETs), or the like. In Embodiment 1, the switching elements SW1, SW2, SW3, SW4, SW5, SW6 are the IGBTs.

The first inverter 12a includes freewheeling diodes D1, D2, D3, D4, D5, D6 respectively connected in parallel with the switching elements SW1, SW2, SW3, SW4, SW5, SW6.

In Embodiment 1, the freewheeling diode DI has an anode connected to an emitter terminal of the switching element SW1, and has a cathode connected to a collector terminal of the switching element SW1. Similarly, the freewheeling diode D2 has an anode connected to an emitter terminal of the switching element SW2, and has a cathode connected to a collector terminal of the switching element SW2.

Similarly, the freewheeling diode D3 has an anode connected to an emitter terminal of the switching element SW3, and has a cathode connected to a collector terminal of the switching element SW3. Similarly, the freewheeling diode D4 has an anode connected to an emitter terminal of the switching element SW4, and has a cathode connected to a collector terminal of the switching element SW4.

Similarly, the freewheeling diode D5 has an anode connected to an emitter terminal of the switching element SW5, and has a cathode connected to a collector terminal of the switching element SW5. Similarly, the freewheeling diode D6 has an anode connected to an emitter terminal of the switching element SW6, and has a cathode connected to a collector terminal of the switching element SW6.

The anodes of the freewheeling diodes D1, D3, D5 are respectively connected to the secondary terminals 23a, 24a, 25a of the first inverter 12a. The cathodes of the freewheeling diodes D1, D3, D5 are connected to the primary terminal 21a corresponding to a positive electrode among the primary terminals 21a, 22a of the first inverter 12a. The anodes of the freewheeling diodes D2, D4, D6 are connected to the primary terminal 22a corresponding to a negative electrode among the primary terminals 21a, 22a of the first inverter 12a. The cathodes of the freewheeling diodes D2, D4, D6 are respectively connected to the secondary terminals 23a, 24a, 25a of the first inverter 12a. The freewheeling diodes D1-D6 regulate an alternating current flowing from the secondary terminals 23a, 24a, 25a of the first inverter 12a, and outputs the regulated current from the primary terminal 21a. In other words, the freewheeling diodes D1-D6 serve as a rectifier circuit that regulates the AC power supplied from the first inverter 12b to convert the AC power into DC power, and supplies the resulting DC power to at least any of the converter 11a and the power storage device 13a.

The switching elements SW1-SW6 of the first inverters 12a, 12b are controlled by the respective controllers 15a, 15b, and thus, the first inverters 12a, 12b convert DC power into AC power or convert AC power into DC power.

As illustrated in FIG. 1, the power storage device 13a is connected to the converter 11a, the first inverter 12a, and the second inverter 14a. The power storage device 13a is charged with power output by the converter 11a or the first inverter 12a. Similarly, the power storage device 13b is connected to the converter 11b, the first inverter 12b, and the second inverter 14b. The power storage device 13b is charged with power output by the converter 11b or the first inverter 12b. The power storage devices 13a, 13b each include any number of secondary batteries and a monitoring device to monitor voltage between the terminals of the secondary battery.

The DC-side terminals of the second inverter 14a are connected to the converter 11a, the first inverter 12a, and the power storage device 13a. The AC-side terminals of the second inverter 14a are connected to the main motor 93a. Similarly, the DC-side terminals of the second inverter 14b are connected to the converter 11b, the first inverter 12b, and the power storage device 13b. The AC-side terminals of the second inverter 14b are connected to the main motor 93b.

Each of the second inverters 14a, 14b includes a capacitor and a plurality of switching elements. The capacitors are charged with DC power output by the corresponding converters 11a, 11b. The switching elements of the second inverters 14a, 14b are controlled by the respective controllers 15a, 15b, and thus, the second inverters 14a, 14b convert DC power into AC power, and supply the resulting AC power to the main motors 93a, 93b. The second inverters 14a, 14b are made of, for example, a power conversion circuit of which output voltage and output frequency are variable.

The transformers 16a, 16b are, for example, delta-star connection transformers. The transformers 16a, 16b transform AC power supplied from the first inverters 12a, 12b connected at the primary side to voltage suitable for the load devices 94a, 94b, and output the resulting AC power from the secondary side.

The AC capacitors 17a, 17b are connected to the respective transformers 16a, 16b at the secondary side. The AC capacitors 17a, 17b form LC filters together with coils included in the respective transformers 16a, 16b, and thus, harmonic components resulting from the switching operation of the first inverters 12a, 12b are reduced.

The power-storage-device contactors 18a, 18b electrically connect or disconnect the respective power storage devices 13a, 13b to or from another electronic device. Specifically, the main conversion device 1a includes the power-storage-device contactors 18a connected to a corresponding positive-electrode terminal and negative-electrode terminal of the power storage device 13a. Upon closing of each of the power-storage-device contactors 18a, the power storage device 13a is connected to the converter 11a, the first inverter 12a, and the second inverter 14a. Upon opening of each of the power-storage-device contactors 18a, the power storage device 13a is electrically disconnected from the converter 11a, the first inverter 12a, and the second inverter 14a.

The main conversion device 1b includes the power-storage-device contactor 18b connected to the positive-electrode terminal of the power storage device 13b, and the power-storage-device contactor 18b connected to the negative-electrode terminal of the power storage device 13b. Upon closing of each of the power-storage-device contactors 18b, the power storage device 13b is connected to the converter 11b, the first inverter 12b, and the second inverter 14b. Upon opening of each of the power-storage-device contactors 18b, the power storage device 13b is electrically disconnected from the converter 11b, the first inverter 12b, and the second inverter 14b.

The inverter contactors 19a, 19b electrically connect the first inverters 12a, 12b to each other or electrically disconnect the first inverters 12a, 12b from each other. Specifically, the main conversion device 1a includes three inverter contactors 19a respectively corresponding to the U phase, the V phase, and the W phase. The main conversion device 1b includes three inverter contactors 19b respectively corresponding to the U phase, the V phase, and the W phase.

Upon closing of each of the inverter contactors 19a, 19b, the secondary terminals 23a, 24a, 25a of the first inverter 12a are electrically connected to the secondary terminals 23b, 24b, 25b of the first inverter 12b. Specifically, upon closing of each of the inverter contactors 19a, 19b, the secondary terminals of the transformers 16a, 16b are electrically connected to each other, and this allows the secondary terminals 23a, 24a, 25a of the first inverter 12a to be conductive with the secondary terminals 23b, 24b, 25b of the first inverter 12b.

Upon opening of each of the inverter contactors 19a, 19b, the secondary terminals 23a, 24a, 25a of the first inverter 12a are electrically disconnected from the secondary terminals 23b, 24b, 25b of the first inverter 12b. Specifically, upon opening of each of the inverter contactors 19a, 19b, the secondary terminals of the transformers 16a, 16b are electrically disconnected from each other, and this causes the secondary terminals 23a, 24a, 25a of the first inverter 12a and the secondary terminals 23b, 24b, 25b of the first inverter 12b to be in a non-conductive state.

The controller 15a controls the switching elements included in the converter 11a, the switching elements SW1-SW6 included in the first inverter 12a, the switching elements included in the second inverter 14a, the power-storage-device contactors 18a, and the inverter contactors 19a. Similarly, the controller 15b controls the switching elements included in the converter 11b, the switching elements SW1-SW6 included in the first inverter 12b, the switching elements included in the second inverter 14b, the power-storage-device contactors 18b, and the inverter contactors 19b.

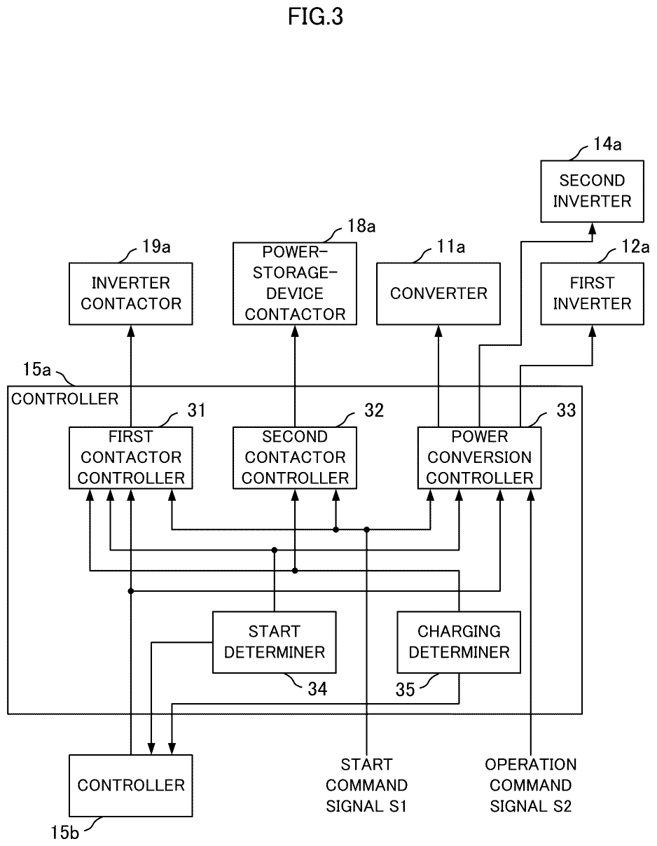

The controllers 15a, 15b have a similar structure. The details of the controller 15a are described. As illustrated in FIG. 3, the controller 15a includes a first contactor controller 31, a second contactor controller 32, and a power conversion controller 33. The first contactor controller 31 closes or opens the inverter contactors 19a. The second contactor controller 32 closes or opens the power-storage-device contactors 18a. The power conversion controller 33 controls the converter 11a, the first inverter 12a, and the second inverter 14a. The controller 15a includes a start determiner 34 and a charging determiner 35. The start determiner 34 determines whether a DC voltage V1 applied to an electric circuit between the converter 11a and the first inverter 12a (hereinafter referred to as an intermediate link voltage) is enough to start the internal combustion engine 91a. The charging determiner 35 determines whether the power storage device 13a is charged based on a voltage of the power storage device 13a.

The first contactor controller 31, the second contactor controller 32, and the power conversion controller 33 acquire a start command signal S1 from the driver cab. The start command signal S1 is, for example, set to a low (L) level to stop the internal combustion engines 91a, 91b and set to a high (H) level to start the internal combustion engines 91a, 91b.

The power conversion controller 33 acquires an operation command signal S2 from the driver cab. The operation command signal S2 indicates, for example, a power running notch that provides instruction for an acceleration of a railway vehicle, a brake notch that provides instruction for a deceleration of the railway vehicle, or the like.

The controller 15a having the aforementioned configuration acquires information from the controller 15b. Specifically, the first contactor controller 31 and the power conversion controller 33 included in the controller 15a acquire a determination result that is a result of determination by the start determiner 34 included in the controller 15b. The first contactor controller 31 included in the controller 15a acquires a determination result that is a result of determination by the charging determiner 35. The determination result of the start determiner 34 included in the controller 15b indicates whether an intermediate link voltage V2 that is a DC voltage applied to the electric circuit between the converter 11b and the first inverter 12b is enough to start the internal combustion engine 91b. The determination result of the charging determiner 35 indicates whether the power storage device 13b is charged.

Various components of the controller 15a are described in detail below. The first contactor controller 31 closes the inverter contactors 19a when only part of the internal combustion engines 91a, 91b is started. Specifically, the first contactor controller 31 closes the inverter contactors 19a when (i) the start command signal S1 is at the H level and (ii) the determination result of the start determiner 34 included in the controller 15a indicates that the intermediate link voltage V1 is not enough to start the internal combustion engine 91a or the determination result of the start determiner 34 included in the controller 15b indicates that the intermediate link voltage V2 is not enough to start the internal combustion engine 91b.

The first contactor controller 31 opens the inverter contactors 19a when, after the closing of the inverter contactors 19a, both of the determination result of the charging determiner 35 included in the controller 15a and the determination result of the charging determiner 35 included in the controller 15b indicate that the power storage devices 13a, 13b are sufficiently charged.

When the start command signal S1 is switched from the L level to the H level, the second contactor controller 32 closes the power-storage-device contactors 18a. The second contactor controller 32 opens the power-storage-device contactors 18a when, after the start of the internal combustion engine 91a, the determination result of the charging determiner 35 indicates that the power storage device 13a is sufficiently charged.

When, after the start command signal S1 is switched from the L level to the H level, the determination result of the start determiner 34 indicates that the intermediate link voltage V1 is enough to start the internal combustion engine 91a, the power conversion controller 33 controls the switching elements of the converter 11a, thereby the converter 11a converting DC power into AC power. Specifically, the converter 11 a converts the DC power supplied from the power storage device 13a into AC power, and supplies the resulting AC power to the power generator 92a. As a result, the power generator 92a operates as an electric motor and rotates, thereby the internal combustion engine 91a of which the output shaft is fixed to the shaft of the power generator 92a rotating to start the internal combustion engine 91a.

Upon start of the internal combustion engine 91a, the power conversion controller 33 controls the switching elements of the converter 11a, thereby the converter 11a converting AC power into DC power. Specifically, when the engine speed of the internal combustion engine 91a acquired from the speed sensor reaches a start engine speed, the power conversion controller 33 controls the switching elements included in the converter 11a. Accordingly, the converter 11a converts the AC power supplied from the power generator 92a that generates power by being driven by the internal combustion engine 91a into DC power, and outputs the resulting DC power. The start engine speed is an engine speed that the internal combustion engine 91a can be regarded as being started and may be determined in accordance with specifications of the internal combustion engine 91a.

The power conversion controller 33 controls the switching elements included in the converter 11a, thereby raising a value of the DC voltage output by the converter 11a to a value appropriate for supply to the first inverter 12a and the second inverter 14a. The power conversion controller 33 acquires a value of the intermediate link voltage V1 from a non-illustrated voltage sensor, and controls the value of the intermediate link voltage V1 to be closer to the value appropriate for supply to the first inverter 12a and the second inverter 14a. The power conversion controller 33 controls the switching elements included in the converter 11a as described above, thereby the DC power being supplied from the converter 11a to the power storage device 13a and the power storage device 13a being charged.

When the value of the intermediate link voltage V1 is the value appropriate for supply to the first inverter 12a and the second inverter 14a, the power conversion controller 33 controls the switching elements SW1-SW6 of the first inverter 12a, thereby the first inverter 12a converting the DC power into AC power. Specifically, the first inverter 12a converts the DC power supplied from the converter 11a into AC power, and supplies the resulting AC power to the load device 94a.

When the operation command signal S2 indicates a powering command, the power conversion controller 33 controls the switching elements of the second inverter 14a. This causes the second inverter 14a to convert the DC power supplied from the converter 11a into AC power, and supply the resulting AC power to the main motor 93a.

The start determiner 34 determines whether the intermediate link voltage V1 is enough to start the internal combustion engine 91a. Specifically, the start determiner 34 acquires a value of the intermediate link voltage V1 from the voltage sensor, and repeatedly determines whether a measured value of the intermediate link voltage V1 is equal to or greater than a start voltage. For example, the start determiner 34 repeats the determination at determined intervals. The start determiner 34 outputs the determination result to the first contactor controller 31, the power conversion controller 33, and the controller 15b. When the measured value of the intermediate link voltage V1 is equal to or greater than the start voltage, the intermediate link voltage V1 can be regarded as being enough to start the internal combustion engine 91a. The start voltage is a voltage value enough to start the internal combustion engine 91a, and may be predetermined in accordance with specifications of the internal combustion engine 91a and the power generator 92a.

The charging determiner 35 determines whether the power storage device 13a is sufficiently charged. Specifically, the charging determiner 35 acquires, from the monitoring device included in the power storage device 13a, a measured value of the voltage between the terminals of the secondary battery included in the power storage device 13a, and repeatedly determines whether the measured value of the voltage between the terminals of the secondary battery is equal to or greater than a charging threshold. For example, the charging determiner 35 repeats the determination at determined intervals. The charging determiner 35 outputs the determination result to the first contactor controller 31, the second contactor controller 32, and the controller 15b. When the measured value of the voltage between the terminals of the secondary battery is equal to or greater than the charging threshold, the power storage device 13a can be regarded as being sufficiently charged. The charging threshold may be determined in accordance with the specifications of the power storage device 13a.

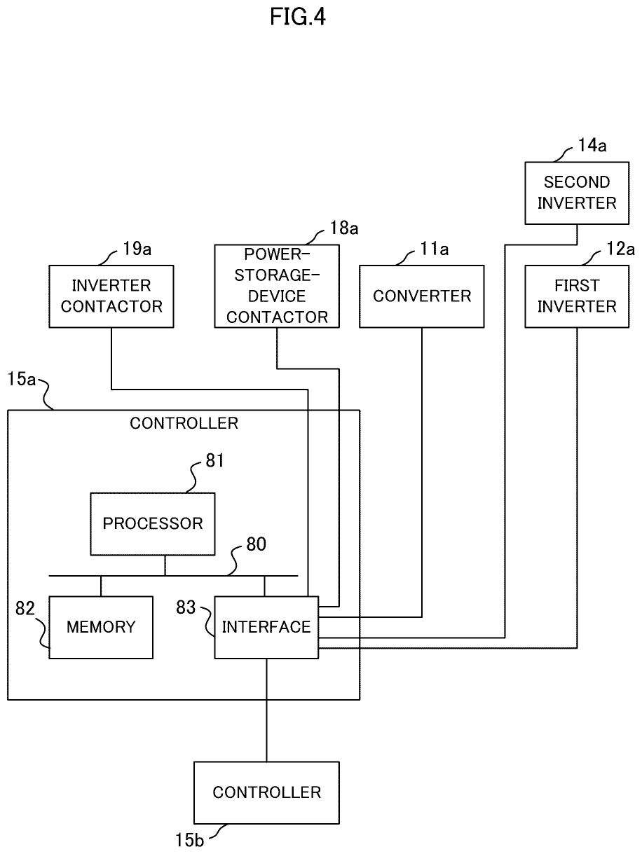

The controllers 15a, 15b having the aforementioned configuration have a similar hardware configuration. The hardware configuration of the controller 15a is described. As illustrated in FIG. 4, the controller 15a includes a processor 81, a memory 82, and an interface 83. The processor 81, the memory 82, and the interface 83 are connected to one another with a bus 80. The functions of the components of the controller 15a are implemented by software, firmware, or a combination of software and firmware. The software and the firmware are described as programs and are stored in the memory 82. The processor 81 reads and executes the programs stored in the memory 82 to implement the functions of the above components. That is, the memory 82 stores programs for executing processing of the components of the controller 15a.

The memory 82 may include, for example, a nonvolatile or volatile semiconductor memory such as a random-access memory (RAM), a read-only memory (ROM), a flash memory, an erasable programmable ROM (EPROM), or an electrically erasable programmable ROM (EEPROM), or a magnetic disk, a flexible disk, an optical disk, a compact disc, a minidisc, or a digital versatile disc (DVD).

The controller 15a is connected through the interface 83 to the controller 15b, the converter 11a, the first inverter 12a, the second inverter 14a, the power-storage-device contactors 18a, and the inverter contactors 19a. The interface 83 includes an interface module complying with one or more standards as appropriate for connection targets.

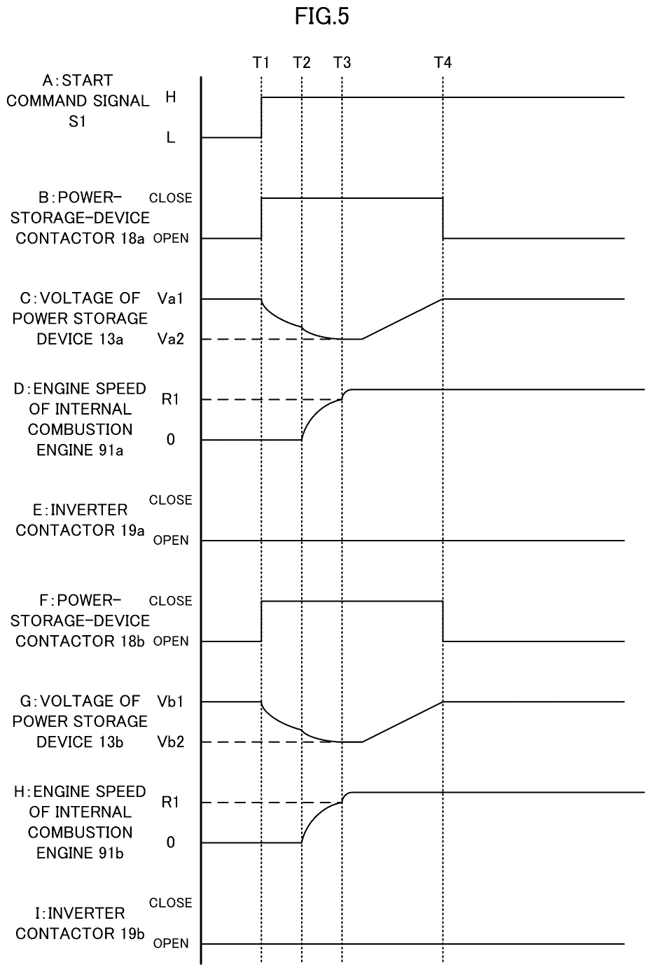

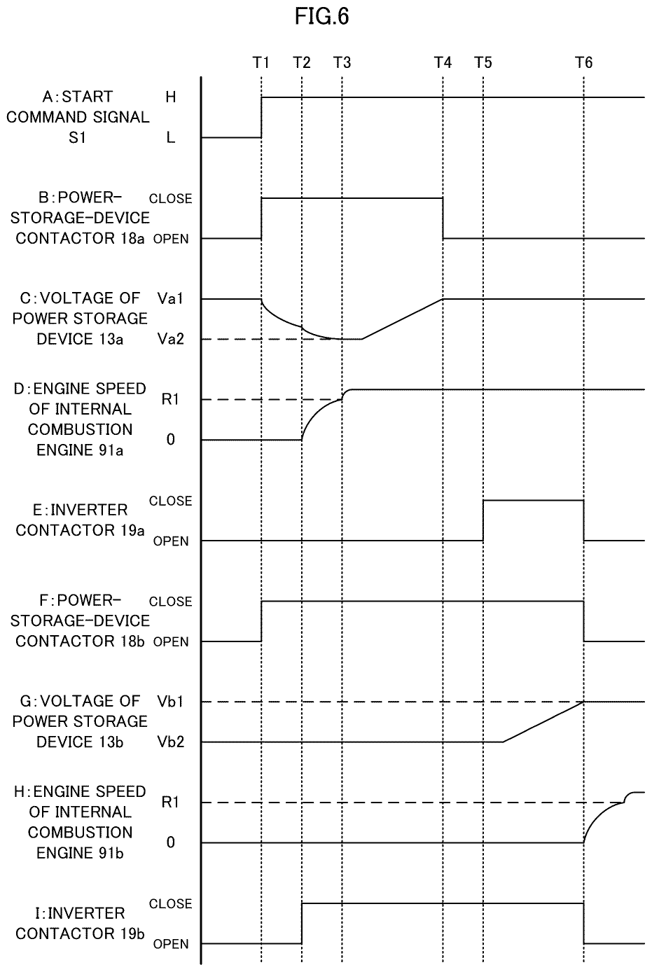

The starting of the internal combustion engines 91a, 91b and the charging of the power storage devices 13a, 13b performed by the drive control apparatus 1 having the aforementioned configuration are described using FIGS. 5 and 6. An example of the operation of the drive control apparatus 1 when both of the power storage devices 13a, 13b are sufficiently charged is illustrated in FIG. 5. As illustrated in graph A of FIG. 5, the timing of switching of the start command signal S1 from the L level to the H level is defined as time T1. At a time earlier than the time T1, it is assumed that the power-storage-device contactors 18a, 18b and the inverter contactors 19a, 19b are open, and the converters 11a, 11b, the first inverters 12a, 12b, and the second inverters 14a, 14b are stopped. Therefore, at the time earlier than the time T1, the internal combustion engines 91a, 91b, the power generators 92a, 92b, the main motors 93a, 93b, and the load devices 94a, 94b are all stopped.

At the time T1, when the start command signal S1 is switched from the L level to the H level, the second contactor controller 32 included in the controller 15a of the main conversion device 1a closes the power-storage-device contactors 18a as illustrated in graph B of FIG. 5. Upon closing of the power-storage-device contactors 18a, DC power is supplied from the power storage device 13a to the converter 11a, and, as illustrated in graph C of FIG. 5, the voltage of the power storage device 13a starts to decrease from the voltage value Va1 at the time T1. The voltage value Va1 is a voltage value of the power storage device 13a in a case where the power storage device 13a is sufficiently charged with power for starting the internal combustion engine 91a. After the time T1, the capacitor included in the converter 11a is charged with the DC power discharged from the power storage device 13a. In other words, the intermediate link voltage V1 increases.

A time at which the capacitor included in the converter 11a is charged with the DC power supplied from the power storage device 13a to the converter 11a and the value of the intermediate link voltage V1 reaches the start voltage is defined as time T2.

At the time T2, the start determiner 34 included in the controller 15a determines that the measured value of the intermediate link voltage V1 is equal to or greater than the start voltage, and sends the determination result to the first contactor controller 31 and the power conversion controller 33 included in each of the controllers 15a, 15b. Since the determination result of the start determiner 34 indicates that the measured value of the intermediate link voltage V1 is equal to or greater than the start voltage, the power conversion controller 33 included in the controller 15a controls the switching elements of the converter 11a, thereby the converter 11a converting the DC power into AC power. Specifically, the converter 11a converts the DC power supplied from the power storage device 13a into AC power, and supplies the resulting AC power to the power generator 92a.

Upon receiving the AC power from the converter 11a, the power generator 92a operates as an electric motor and rotates. Since the shaft of the power generator 92a is fixed to the output shaft of the internal combustion engine 91a, the rotation of the power generator 92a causes the rotation of the internal combustion engine 91a, which results in increasing the engine speed of the internal combustion engine 91a as illustrated in graph D of FIG. 5. A time at which the engine speed of the internal combustion engine 91a reaches a start engine speed RI thereafter, and the internal combustion engine 91a is started is defined as time T3. After the time T3, the engine speed of the internal combustion engine 91a increases. The power generator 92a is therefore capable of generating power.

At the time T3, when the engine speed of the internal combustion engine 91a reaches an engine speed at which power can be generated by the power generator 92a after the start of the internal combustion engine 91a, the power generator 92a driven by the internal combustion engine 91 a starts generating power. The power generator 92a supplies the generated AC power to the converter 11a.

After the start of the internal combustion engine 91a at the time T3, when the AC power is supplied from the power generator 92a to the converter 11a, the power conversion controller 33 included in the controller 15a controls the switching elements of the converter 11a, thereby the converter 11a converting the AC power into DC power. Specifically, the converter 11a converts the AC power supplied from the power generator 92a that generates power by being driven by the internal combustion engine 91a into DC power, and outputs the resulting DC power.

After the time T3, the power conversion controller 33 included in the controller 15a controls the switching elements included in the converter 11a, thereby raising a value of the DC voltage output by the converter 11a to a value appropriate for supply to the first inverter 12a and the second inverter 14a. The power conversion controller 33 of the controller 15a controls the switching elements included in the converter 11a as described above, thereby the converter 11a supplying the DC power to the power storage device 13a. Thus, the discharged power storage device 13a is charged, and, as illustrated in graph C of FIG. 5, the voltage of the power storage device 13a starts to rise from the voltage value Va2. The voltage value Va2 is lower than the voltage value Va1 and is a value of voltage that allows re-charging of the power storage device 13a without overdischarge. A time at which the voltage of the power storage device 13a reaches the voltage value Va1 thereafter, and the charging of the power storage device 13a is completed is defined as time T4. In other words, at the time T4, the power storage device 13a is charged with power enough to start the internal combustion engine 91a next.

At the time T4, the charging determiner 35 included in the controller 15a determines that the measured value of the voltage between the terminals of the secondary battery included in the power storage device 13a is equal to or greater than the charging threshold, and sends the determination result to the first contactor controller 31 included in each of the controllers 15a, 15b and the second contactor controller 32 included in the controller 15a.

At the time T4, when the determination result of the charging determiner 35 included in the controller 15a indicates that the measured value of the voltage between the terminals of the secondary battery included in the power storage device 13a is equal to or greater than the charging threshold, the second contactor controller 32 included in the controller 15a opens the power-storage-device contactors 18a as illustrated in graph B of FIG. 5.

After the time T3 at which the internal combustion engine 91a is started, the power conversion controller 33 included in the controller 15a controls the switching elements included in the converter 11a as described above, thereby raising the value of the intermediate link voltage V1 to a value appropriate for supply to the first inverter 12a and the second inverter 14a. In other words, the capacitor C1 included in the first inverter 12a and the capacitor included in the second inverter 14a are sufficiently charged.

After the time T3, when the measured value of the intermediate link voltage V1 acquired from the voltage sensor increases to a value appropriate for operation of the first inverter 12a, the power conversion controller 33 included in the controller 15a controls the switching elements SW1-SW6 of the first inverter 12a, thereby the first inverter 12a converting the DC power into AC power. Specifically, the first inverter 12a converts the DC power supplied from the converter 11a into AC power, and supplies the resulting AC power to the load device 94a. This allows the load device 94a to operate.

After the time T3, when the measured value of the intermediate link voltage V1 acquired from the voltage sensor increases to a value appropriate for operation of the second inverter 14a and the operation command signal S2 indicates the powering command, the power conversion controller 33 included in the controller 15a controls the switching elements of the second inverter 14a in accordance with the powering command, thereby the second inverter 14a converting the DC power into AC power. Specifically, the second inverter 14a converts the DC power supplied from the converter 11a into AC power, and supplies the resulting AC power to the main motor 93a. The rotation of the main motor 93a receiving the AC power generates propulsion of the railway vehicle.

The operation of the main conversion device 1b is similar to the operation of the main conversion device 1a described above. Specifically, at the time T1, when the start command signal S1 is switched from the L level to the H level, the second contactor controller 32 included in the controller 15b closes the power-storage-device contactors 18b as illustrated in graph F of FIG. 5. Upon closing of the power-storage-device contactors 18b, DC power is supplied from the power storage device 13b to the converter 11b, and, as illustrated in graph G of FIG. 5, the voltage of the power storage device 13b starts to decrease from the voltage value Vb1 at the time T1. The voltage value Vb1 is a voltage value of the power storage device 13b in a case where the power storage device 13b is sufficiently charged with power for starting the internal combustion engine 91b. After the time T1, the capacitor included in the converter 11b is charged with the DC power discharged from the power storage device 13b. In other words, the intermediate link voltage V2 increases.

At the time T2, the capacitor included in the converter 11b is charged with the DC power supplied from the power storage device 13b to the converter 11b, and the value of the intermediate link voltage V2 reaches the threshold voltage.

At the time T2, the start determiner 34 included in the controller 15b determines that the measured value of the intermediate link voltage V2 is equal to or greater than the start voltage, and sends the determination result to the first contactor controller 31 and the power conversion controller 33 included in each of the controllers 15a, 15b. Since the determination result of the start determiner 34 indicates that the measured value of the intermediate link voltage V2 is equal to or greater than the start voltage, the power conversion controller 33 included in the controller 15b controls the switching elements of the converter 11b, thereby the converter 11b converting the DC power into AC power. Specifically, the converter 11b converts the DC power supplied from the power storage device 13b into AC power, and supplies the resulting AC power to the power generator 92b.

Upon receiving the AC power from the converter 11b, the power generator 92b operates as an electric motor and rotates. Since the shaft of the power generator 92b is fixed to the output shaft of the internal combustion engine 91b, the rotation of the power generator 92b causes the rotation of the internal combustion engine 91b, which results in increasing the engine speed of the internal combustion engine 91b as illustrated in graph H of FIG. 5. Thereafter, at the time T3, the engine speed of the internal combustion engine 91b reaches the start engine speed R1, and the internal combustion engine 91b is started. After the time T3, the engine speed of the internal combustion engine 91b increases. The power generator 92b is therefore capable of generating power.

At the time T3, when the engine speed of the internal combustion engine 91b reaches an engine speed at which power can be generated by the power generator 92b after the start of the internal combustion engine 91b, the power generator 92b driven by the internal combustion engine 91b starts generating power. The power generator 92b supplies the generated AC power to the converter 11b.

After the start of the internal combustion engine 91b at the time T3, when the AC power is supplied from the power generator 92b to the converter 11b, the power conversion controller 33 included in the controller 15b controls the switching elements of the converter 11b, thereby the converter 11b converting the AC power into DC power. Specifically, the converter 11b converts the AC power supplied from the power generator 92b that generates power by being driven by the internal combustion engine 91b into DC power, and outputs the resulting DC power.

After the time T3, the power conversion controller 33 included in the controller 15b controls the switching elements included in the converter 11b, thereby raising a value of the DC voltage output by the converter 11b to a value appropriate for supply to the first inverter 12b and the second inverter 14b. The power conversion controller 33 of the controller 15b controls the switching elements included in the converter 11b as described above, thereby the converter 11b supplying the DC power to the power storage device 13b. Thus, the discharged power storage device 13b is charged, and, as illustrated in graph G of FIG. 5, the voltage of the power storage device 13b starts to rise from the voltage value Vb2. The voltage value Vb2 is lower than the voltage value Vb1 and is a value of voltage that allows re-charging of the power storage device 13a without overdischarge. Thereafter, at the time T4, the voltage of the power storage device 13b reaches the voltage value Vb1, and the charging of the power storage device 13b is completed. In other words, at the time T4, the power storage device 13b is charged with power enough to start the internal combustion engine 91b next.

At the time T4, the charging determiner 35 included in the controller 15b determines that the measured value of the voltage between the terminals of the secondary battery included in the power storage device 13b is equal to or greater than the charging threshold, and sends the determination result to the first contactor controller 31 included in each of the controllers 15a, 15b and the second contactor controller 32 included in the controller 15b.

At the time T4, when the determination result of the charging determiner 35 included in the controller 15b indicates that the measured value of the voltage between the terminals of the secondary battery included in the power storage device 13b is equal to or greater than the charging threshold, the second contactor controller 32 included in the controller 15b opens the power-storage-device contactors 18b as illustrated in graph F of FIG. 5.

After the time T3 at which the internal combustion engine 91b is started, the power conversion controller 33 included in the controller 15b controls the switching elements included in the converter 11b as described above, thereby raising the value of the intermediate link voltage V2 to a value appropriate for supply to the first inverter 12b and the second inverter 14b. In other words, the capacitor C1 included in the first inverter 12b and the capacitor included in the second inverter 14b are sufficiently charged.

After the time T3, when the measured value of the intermediate link voltage V2 acquired from the voltage sensor increases to a value appropriate for operation of the first inverter 12b, the power conversion controller 33 included in the controller 15b controls the switching elements SW1-SW6 of the first inverter 12b, thereby the first inverter 12b converting the DC power into AC power. Specifically, the first inverter 12b converts the DC power supplied from the converter 11b into AC power, and supplies the resulting AC power to the load device 94b. This allows the load device 94b to operate.

After the time T3, when the value of the intermediate link voltage V2 acquired from the voltage sensor increases to a value appropriate for operation of the second inverter 14b and the operation command signal S2 indicates the powering command, the power conversion controller 33 included in the controller 15b controls the switching elements of the second inverter 14b in accordance with the powering command, thereby the second inverter 14b converting the DC power into AC power. Specifically, the second inverter 14b converts the DC power supplied from the converter 11b into AC power, and supplies the resulting AC power to the main motor 93b. The rotation of the main motor 93b receiving the AC power generates propulsion of the railway vehicle.

As described above, at the time T2, the start determiners 34 included in the controllers 15a, 15b determine that the values of the intermediate link voltages V1, V2 are equal to or greater than the start voltage. In other words, the determination results acquired by the first contactor controller 31 included in the controller 15a indicate that the intermediate link voltage V1 is enough to start the internal combustion engine 91a and the intermediate link voltage V2 is enough to start the internal combustion engine 91b. The same applies to the determination results acquired by the first contactor controller 31 included in the controller 15b. Therefore, the first contactor controllers 31 included in the controllers 15a, 15b maintain the inverter contactors 19a, 19b open. As illustrated in graphs E and I of FIG. 5, the inverter contactors 19a, 19b remain opened.

An example of the operation of the drive control apparatus 1 when the power storage device 13a is sufficiently charged and the power storage device 13b is discharged is illustrated in FIG. 6. FIG. 6 is viewed in a manner similar to that of FIG. 5. The operation of the main conversion device 1a included in the drive control apparatus 1 from the time T1 to the time T4 is similar to that of the example of FIG. 5.

In the main conversion device 1b, the power storage device 13b is discharged, and thus, the value of the voltage between the terminals of the secondary battery included in the power storage device 13b is sufficiently small at the time T1. For example, as illustrated in graph G of FIG. 6, the value of the voltage between the terminals of the secondary battery included in the power storage device 13b is the voltage value Vb2. At the time T1, when the start command signal S1 is switched from the L level to the H level, the second contactor controller 32 included in the controller 15b closes the power-storage-device contactors 18b as illustrated in graph F of FIG. 6. Even if the power-storage-device contactors 18b are closed, since the power storage device 13b is discharged, DC power enough to start the internal combustion engine 91b is not supplied from the power storage device 13b to the converter 11b.

Therefore, at the time T2, the value of the intermediate link voltage V2 does not reach the start voltage in the main conversion device 1b. At the time T2, the start determiner 34 included in the controller 15b determines that the intermediate link voltage V2 is less than the start voltage, and sends the determination result to the first contactor controller 31 and the power conversion controller 33 included in each of the controllers 15a, 15b.

When acquiring the determination result indicating that the intermediate link voltage V2 is less than the start voltage, the first contactor controller 31 included in the controller 15b closes the inverter contactors 19b as illustrated in graph I of FIG. 6.

When acquiring the determination result indicating that the intermediate link voltage V2 is less than the start voltage, the power conversion controller 33 included in the controller 15b maintains the converter 11b, the first inverter 12b, and the second inverter 14b stopped. Therefore, as illustrated in graph H of FIG. 6, the internal combustion engine 91b cannot be started.

The operation of the drive control apparatus 1 after the time T4 is described below. When the charging of the power storage device 13a is completed and the power-storage-device contactors 18a are opened at the time T4, similarly to Embodiment 1, the power conversion controller 33 included in the controller 15a controls the switching elements of the converter 11a, thereby the value of the intermediate link voltage V1 increasing to a value appropriate for supply to the first inverter 12a and the second inverter 14a.

After the time T4, when the measured value of the intermediate link voltage V1 acquired from the voltage sensor reaches a value appropriate for operation of the first inverter 12a, the power conversion controller 33 included in the controller 15a controls the switching elements SW1-SW6 of the first inverter 12a, thereby the first inverter 12a converting the DC power into AC power. Specifically, the first inverter 12a converts the DC power supplied from the converter 11a into AC power, and supplies the resulting AC power to the load device 94a. This allows the load device 94a to operate.

At the time T2, the power conversion controller 33 included in the controller 15a acquires the determination result indicating that the intermediate link voltage V2 is less than the start voltage. Therefore, after the time T4, even if the measured value of the intermediate link voltage V1 acquired from the voltage sensor increases to a value appropriate for operation of the second inverter 14a and the operation command signal S2 indicates the powering command, the power conversion controller 33 included in the controller 15a maintains the second inverter 14a stopped. This suppresses the railway vehicle from starting to move while only part of the internal combustion engines 91a, 91b is started.

At the time T2, the first contactor controller 31 included in the controller 15a acquires the determination result indicating that the intermediate link voltage V2 is less than the start voltage. A time at which the first contactor controller 31 controls the inverter contactors 19a in accordance with the determination result is defined as time T5. Specifically, as illustrated in graph E of FIG. 6, after the internal combustion engine 91a is started and the power storage device 13a is charged based on the power generated by the power generator 92a driven by the internal combustion engine 91a, the first contactor controller 31 included in the controller 15a closes the inverter contactors 19a at the time T5.

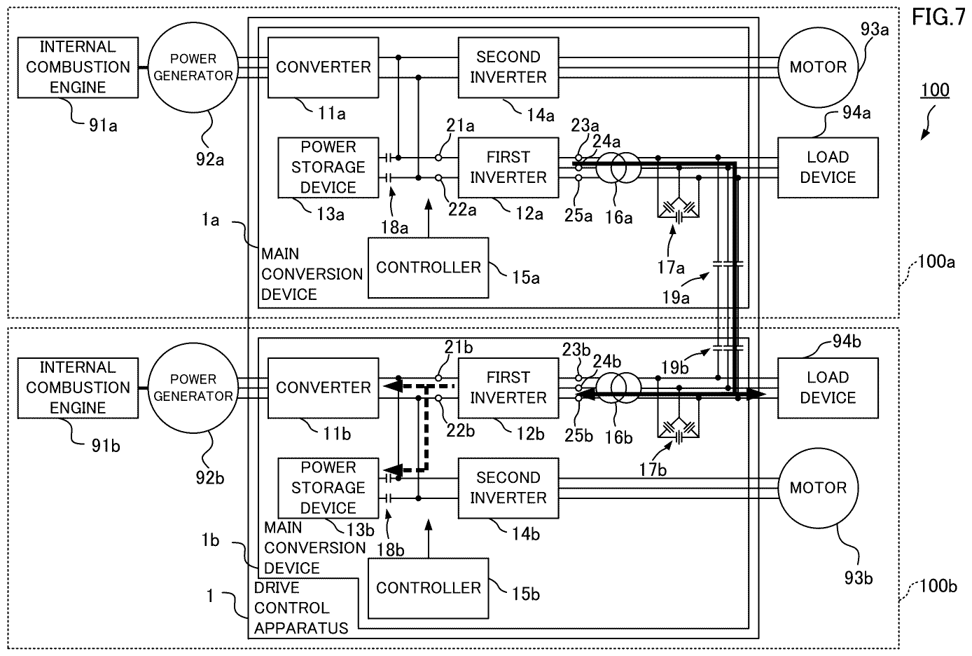

The inverter contactors 19b have already been closed at the time T2, and thus, when the inverter contactors 19a are closed at the time T5, the secondary terminals 23b, 24b, 25b of the first inverter 12b connected via the power generator 92b and the converter 11b to the unstarted internal combustion engine 91b are electrically connected to the secondary terminals 23a, 24a, 25a of the first inverter 12a connected via the power generator 92a and the converter 11a to the started internal combustion engine 91a. In other words, the secondary terminals 23b, 24b, 25b of the first inverter 12b are conductive with the secondary terminals 23a, 24a, 25a of the first inverter 12a by the inverter contactors 19a, 19b being closed. The inverter contactors 19a, 19b are installed in an electric circuit between the first inverter 12b connected via the power generator 92b and the converter 11b to the unstarted internal combustion engine 91b and the first inverter 12a connected via the power generator 92a and the converter 11a to the started internal combustion engine 91a. As a result, as indicated by solid arrows in FIG. 7, the AC power output by the first inverter 12a is supplied via the inverter contactors 19a, 19b to the first inverter 12b and the load device 94b. This allows the load device 94b to operate.

When the AC power is supplied from the first inverter 12a to the secondary side of the first inverter 12b in a state in which the switching elements SW1-SW6 are off, the first inverter 12b rectifies the AC power to convert into DC power, and outputs the resulting DC power. Specifically, the AC power supplied to the secondary side of the first inverter 12b is rectified by the freewheeling diodes D1-D6 illustrated in FIG. 2. As indicated by dotted-line arrows in FIG. 7, the first inverter 12b supplies the DC power to the converter 11b and the power storage device 13b.

Thus, when the power storage device 13b is charged, as illustrated in graph G of FIG. 6, the voltage of the power storage device 13b starts to rise. A time at which the charging of the power storage device 13b is completed thereafter is defined as time T6. In other words, at the time T6, the power storage device 13b is charged with power enough to start the internal combustion engine 91b.

At the time T6, the charging determiner 35 included in the controller 15b determines that the measured value of the voltage between the terminals of the secondary battery included in the power storage device 13b is equal to or greater than the charging threshold, and sends the determination result to the first contactor controller 31 included in each of the controllers 15a, 15b and the second contactor controller 32 included in the controller 15b.

As illustrated in graphs E and I of FIG. 6, at the time T6, upon acquiring the determination result indicating that the measured value of the voltage between the terminals of the secondary battery included in the power storage device 13b is equal to or greater than the charging threshold in a state in which the inverter contactors 19a, 19b are closed, the first contactor controllers 31 included in the controllers 15a, 15b open the respective inverter contactors 19a, 19b.

As illustrated in graph F of FIG. 6, at the time T6, when acquiring the determination result indicating that the measured value of the voltage between the terminals of the secondary battery included in the power storage device 13b is equal to or greater than the charging threshold, the second contactor controller 32 included in the controller 15b opens the power-storage-device contactors 18b.

From the time T5 to the time T6, the capacitor included in the converter 11b is charged with the DC power supplied from the first inverter 12b, the intermediate link voltage V2 reaches the start voltage at the time T6.

At the time T6, the start determiner 34 included in the controller 15b determines that the measured value of the intermediate link voltage V2 is equal to or greater than the start voltage, and sends the determination result to the first contactor controller 31 and the power conversion controller 33 included in each of the controllers 15a, 15b.

After the time T6, the power conversion controller 33 included in the controller 15b controls the switching elements included in the converter 11b, thereby the AC power being supplied from the converter 11b to the power generator 92b. As such, the internal combustion engine 91b can be started as illustrated in graph H of FIG. 6. The operation of the drive control apparatus 1 upon starting the internal combustion engine 91b is similar to that of the example of FIG. 5.

As described above, with respect to the drive control apparatus 1 according to Embodiment 1, both of the power storage devices 13a, 13b can be charged when only part of the internal combustion engines 91a, 91b is started due to discharging of either one of the power storage devices 13a, 13b. The drive control apparatus 1 that facilitates charging of the power storage devices 13a, 13b is obtained as removing, from the railway vehicle, a discharged power storage device 13a or power storage device 13b for charging at the charging facility is unnecessary even when either one of the power storage devices 13a, 13b is discharged.

### Embodiment 2

The charging method of power storage devices 13a, 13b is not limited to the foregoing examples. A drive control apparatus 1 that charges the power storage devices 13a, 13b using a method different from that of Embodiment 1 is described in Embodiment 2. The configuration of the drive control apparatus 1 according to Embodiment 2 is similar to that in Embodiment 1. However, the second contactor controllers 32 included in the controllers 15a, 15b acquire the determination result from the start determiners 34, and acquire engine speed of the internal combustion engines 91a, 91b from the speed sensor.

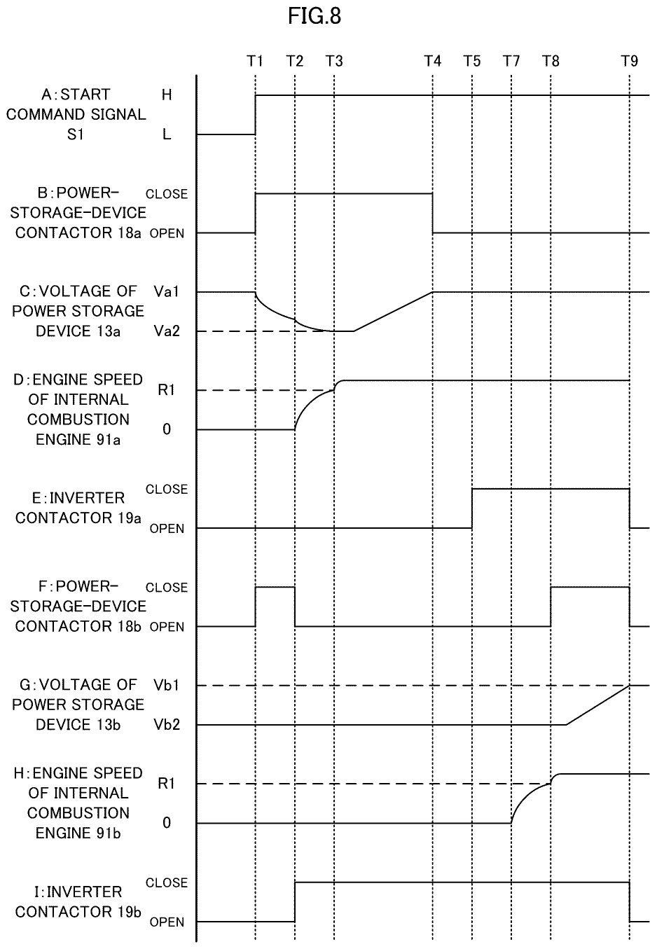

An operation of the drive control apparatus 1 when both of the power storage devices 13a, 13b are sufficiently charged is similar to that in Embodiment 1. An example of the operation of the drive control apparatus 1 when the power storage device 13a is sufficiently charged and the power storage device 13b is discharged is illustrated in FIG. 8. FIG. 8 is viewed in a manner similar to that of FIG. 6. The operation of the main conversion device 1a included in the drive control apparatus 1 from the time T1 to the time T4 is similar to the operation of the main conversion device 1a according to Embodiment 1 illustrated in FIG. 6.

In the main conversion device 1b, the power storage device 13b is discharged, and thus, the value of the voltage between the terminals of the secondary battery included in the power storage device 13b is sufficiently small at the time T1. For example, as illustrated in graph G of FIG. 8, the value of the voltage between the terminals of the secondary battery included in the power storage device 13b is the voltage value Vb2. At the time T1, when the start command signal S1 is switched from the L level to the H level, the second contactor controller 32 included in the controller 15b closes the power-storage-device contactors 18b as illustrated in graph F of FIG. 8. Even if the power-storage-device contactors 18b are closed, since the power storage device 13b is discharged, DC power enough to start the internal combustion engine 91b is not supplied from the power storage device 13b to the converter 11b.

Therefore, at the time T2, the value of the intermediate link voltage V2 does not reach the start voltage in the main conversion device 1b. At the time T2, the start determiner 34 included in the controller 15b determines that the intermediate link voltage V2 is less than the start voltage, and sends the determination result to the first contactor controller 31 and the power conversion controller 33 included in each of the controllers 15a, 15b and the second contactor controller 32 included in the controller 15b.

When acquiring the determination result indicating that the intermediate link voltage V2 is less than the start voltage, the first contactor controller 31 included in the controller 15b closes the inverter contactors 19b as illustrated in graph I of FIG. 8.

When acquiring the determination result indicating that the intermediate link voltage V2 is less than the start voltage, the second contactor controller 32 included in the controller 15b opens the power-storage-device contactors 18b as illustrated in graph F of FIG. 8.

When acquiring the determination result indicating that the intermediate link voltage V2 is less than the start voltage, the power conversion controller 33 included in the controller 15b maintains the converter 11b, the first inverter 12b, and the second inverter 14b stopped. Therefore, as illustrated in graph H of FIG. 8, at the time T2 at which the engine speed of the internal combustion engine 91a starts increasing, the engine speed of the internal combustion engine 91b does not increase, and the internal combustion engine 91b cannot be started.

The operation of the drive control apparatus 1 after the time T4 is described below. When the charging of the power storage device 13a is completed and the power-storage-device contactors 18a are opened at the time T4, similarly to Embodiment 1, the power conversion controller 33 included in the controller 15a controls the switching elements of the converter 11a, thereby the value of the intermediate link voltage V1 increasing to a value appropriate for supply to the first inverter 12a and the second inverter 14a.

After the time T4, when the measured value of the intermediate link voltage V1 acquired from the voltage sensor reaches a value appropriate for operation of the first inverter 12a, the power conversion controller 33 included in the controller 15a controls the switching elements SW1-SW6 of the first inverter 12a, thereby the first inverter 12a converting the DC power into AC power. Specifically, the first inverter 12a converts the DC power supplied from the converter 11a into AC power, and supplies the resulting AC power to the load device 94a. This allows the load device 94a to operate.

At the time T2, the power conversion controller 33 included in the controller 15a acquires the determination result indicating that the intermediate link voltage V2 is less than the start voltage. Therefore, after the time T4, even if the measured value of the intermediate link voltage V1 acquired from the voltage sensor increases to a value appropriate for operation of the second inverter 14a and the operation command signal S2 indicates the powering command, the power conversion controller 33 included in the controller 15a maintains the second inverter 14a stopped. This suppresses the railway vehicle from starting to move while only part of the internal combustion engines 91a, 91b is started.

At the time T2, the first contactor controller 31 included in the controller 15a acquires the determination result indicating that the intermediate link voltage V2 is less than the start voltage. In accordance with this determination result, the first contactor controller 31 included in the controller 15a closes the inverter contactors 19a at the time T5 as illustrated in graph E of FIG. 8.

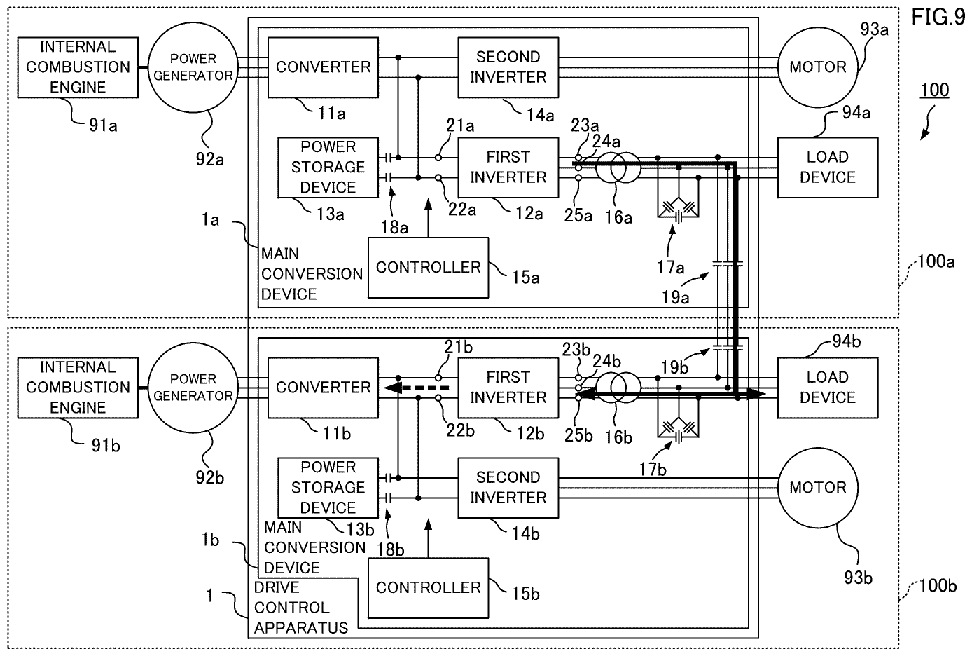

The inverter contactors 19b have already been closed at the time T2, and thus, when the inverter contactors 19a are closed at the time T5, the secondary terminals 23b, 24b, 25b of the first inverter 12b connected via the power generator 92b and the converter 11b to the unstarted internal combustion engine 91b are electrically connected to the secondary terminals 23a, 24a, 25a of the first inverter 12a connected via the power generator 92a and the converter 11a to the started internal combustion engine 91a. In other words, the secondary terminals 23b, 24b, 25b of the first inverter 12b are conductive with the secondary terminals 23a, 24a, 25a of the first inverter 12a by the inverter contactors 19a, 19b being closed. The inverter contactors 19a, 19b are installed in an electric circuit between the first inverter 12b connected via the power generator 92b and the converter 11b to the unstarted internal combustion engine 91b and the first inverter 12a connected via the power generator 92a and the converter 11a to the started internal combustion engine 91a. As a result, as indicated by solid arrows in FIG. 9, the AC power output by the first inverter 12a is supplied via the inverter contactors 19a, 19b to the first inverter 12b and the load device 94b. This allows the load device 94b to operate.

Similarly to Embodiment 1, when the AC power is supplied from the first inverter 12a to the secondary side of the first inverter 12b in a state in which the switching elements SW1-SW6 are off, the first inverter 12b rectifies the AC power to convert into DC power, and outputs the resulting DC power. As indicated by dotted-line arrows in FIG. 9, the first inverter 12b supplies the DC power to the converter 11b. Since the power-storage-device contactors 18a are open at the time T5, the DC power is not supplied from the first inverter 12b to the power storage device 13a.

After the time T5 illustrated in FIG. 8, when the capacitor included in the converter 11b is charged with the DC power supplied from the first inverter 12b, the voltage of the capacitor, that is, the intermediate link voltage V2 increases. A time at which the capacitor included in the converter 11b is charged and the measured value of the intermediate link voltage V2 reaches the start voltage is defined as time T7.

At the time T7, the start determiner 34 included in the controller 15b determines that measured value of the intermediate link voltage V2 is equal to or greater than the start voltage, and outputs the determination result to the first contactor controller 31 and the power conversion controller 33 included in each of the controllers 15a, 15b and the second contactor controller 32 included in the controller 15b.

Since the determination result of the start determiner 34 indicates that the measured value of the intermediate link voltage V1 is equal to or greater than the start voltage, the power conversion controller 33 included in the controller 15b controls the switching elements of the converter 11b, thereby the converter 11b converting the DC power into AC power. Specifically, the converter 11b converts the DC power supplied from the first inverter 12b into AC power, and supplies the resulting AC power to the power generator 92b.

Upon receiving the AC power from the converter 11b, the power generator 92b operates as an electric motor and rotates. Since the shaft of the power generator 92b is fixed to the output shaft of the internal combustion engine 91b, the rotation of the power generator 92b causes the rotation of the internal combustion engine 91b, which results in increasing the engine speed of the internal combustion engine 91b as illustrated in graph H of FIG. 8. A time at which the engine speed of the internal combustion engine 91b reaches a start engine speed RI thereafter, and the internal combustion engine 91b is started is defined as time T8. After the time T8, the engine speed of the internal combustion engine 91a increases. The power generator 92a is therefore capable of generating power.

At the time T8, when the engine speed of the internal combustion engine 91b reaches the start engine speed R1, the second contactor controller 32 included in the controller 15b closes the power-storage-device contactors 18b as illustrated in graph F of FIG. 8.

At the time T8, when the engine speed of the internal combustion engine 91b reaches an engine speed at which power can be generated by the power generator 92b after the start of the internal combustion engine 91b, the power generator 92b driven by the internal combustion engine 91b starts generating power. The power generator 92b supplies the generated AC power to the converter 11b.

When the internal combustion engine 91b is started at time T8 and the AC power is supplied from the power generator 92b to the converter 11b, the power conversion controller 33 included in the controller 15b controls the switching elements of the converter 11b, thereby the converter 11b converting the AC power into DC power. Specifically, the converter 11b converts the AC power supplied from the power generator 92b that generates power by being driven by the internal combustion engine 91b into DC power, and outputs the resulting DC power.

After the time T8, the power conversion controller 33 included in the controller 15b controls the switching elements included in the converter 11b, thereby raising a value of the DC voltage output by the converter 11b to a value appropriate for supply to the first inverter 12b and the second inverter 14b. The power conversion controller 33 of the controller 15b controls the switching elements included in the converter 11b as described above, thereby the converter 11b supplying the DC power to the power storage device 13b. Thus, the power storage device 13b is charged, and, as illustrated in graph G of FIG. 8, the voltage of the power storage device 13b starts to rise from the voltage value Vb2. A time at which the charging of the power storage device 13b is completed thereafter is defined as time T9. In other words, at the time T9, the power storage device 13b is charged with power enough to start the internal combustion engine 91b next.

At the time T9, the charging determiner 35 included in the controller 15b determines that the measured value of the voltage between the terminals of the secondary battery included in the power storage device 13b is equal to or greater than the charging threshold, and sends the determination result to the first contactor controller 31 included in each of the controllers 15a, 15b and the second contactor controller 32 included in the controller 15b.

As illustrated in graphs E and I of FIG. 8, at the time T9, upon acquiring the determination result indicating that the measured value of the voltage between the terminals of the secondary battery included in the power storage device 13b is equal to or greater than the charging threshold in a state in which the inverter contactors 19a, 19b are closed, the first contactor controllers 31 included in the controllers 15a, 15b open the respective inverter contactors 19a, 19b.

As illustrated in graph F of FIG. 8, at the time T9, when acquiring the determination result indicating that the measured value of the voltage between the terminals of the secondary battery included in the power storage device 13b is equal to or greater than the charging threshold, the second contactor controller 32 included in the controller 15b opens the power-storage-device contactors 18b.

After the time T8 at which the internal combustion engine 91b is started, the power conversion controller 33 included in the controller 15b controls the switching elements included in the converter 11b as described above, thereby raising the value of the intermediate link voltage V2 to a value appropriate for supply to the first inverter 12b and the second inverter 14b. In other words, the capacitor C1 included in the first inverter 12b and the capacitor included in the second inverter 14b are sufficiently charged.

After the time T8, when the measured value of the intermediate link voltage V2 acquired from the voltage sensor increases to a value appropriate for operation of the first inverter 12b, the power conversion controller 33 included in the controller 15b controls the switching elements SW1-SW6 of the first inverter 12b, thereby the first inverter 12b converting the DC power into AC power. Specifically, the first inverter 12b converts the DC power supplied from the converter 11b into AC power, and supplies the resulting AC power to the load device 94b. This allows the load device 94b to operate.

After the time T8, when the measured value of the intermediate link voltage V1 acquired from the voltage sensor increases to a value appropriate for operation of the second inverter 14a and the operation command signal S2 indicates the powering command, the power conversion controller 33 included in the controller 15a controls the switching elements included in the second inverter 14a in accordance with the powering command, thereby the second inverter 14a converting the DC power into AC power. Specifically, the second inverter 14a converts the DC power supplied from the converter 11a into AC power, and supplies the resulting AC power to the main motor 93a. The rotation of the main motor 93a receiving the AC power generates propulsion of the railway vehicle.

Similarly, after the time T8, when the measured value of the intermediate link voltage V2 acquired from the voltage sensor increases to a value appropriate for operation of the second inverter 14b and the operation command signal S2 indicates the powering command, the power conversion controller 33 included in the controller 15b controls the switching elements included in the second inverter 14b in accordance with the powering command, thereby the second inverter 14b converting the DC power into AC power. Specifically, the second inverter 14b converts the DC power supplied from the converter 11b into AC power, and supplies the resulting AC power to the main motor 93b. The rotation of the main motor 93b receiving the AC power generates propulsion of the railway vehicle.

As described above, the drive control apparatus 1 according to Embodiment 2 enables to start both of the internal combustion engines 91a, 91b even when one of the power storage devices 13a, 13b is discharged. The drive control apparatus 1 that facilitates charging of the power storage devices 13a, 13b is obtained as removing, from the railway vehicle, a discharged power storage device 13a or power storage device 13b for charging at the charging facility is unnecessary even when either one of the power storage devices 13a, 13b is discharged.

The above-described examples are not to be construed as limiting the present disclosure. The above-described circuit configurations are mere examples and may be modified appropriately. In one example, the first inverters 12a, 12b may have any circuit configurations other the example of FIG. 2 provided that a circuit allows conversion of power from DC power into AC power upon supply of DC power from the converters 11a, 11b and allows conversion of power from AC power into DC power upon supply of AC power from another first inverter 12a or 12b.

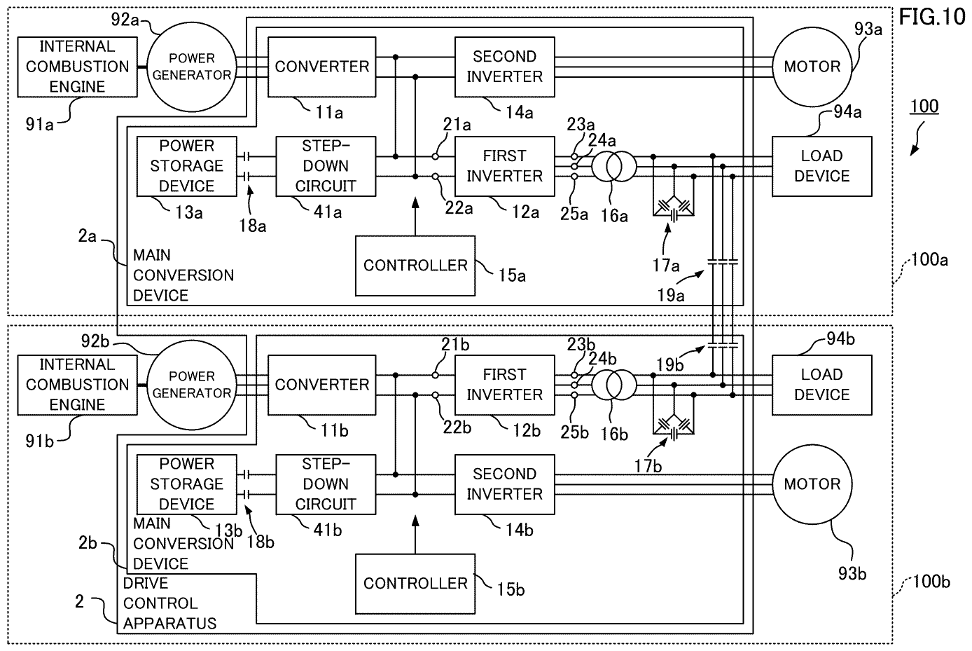

In another example, the drive control apparatus 2 illustrated in FIG. 10 further includes, in addition to the configuration of the above-described drive control apparatus 1, step-down circuits 41a, 41b. The step-down circuits 41a, 41b lower the voltage of the DC power supplied from the converters 11a, 11b, and supply the DC power with the lowered voltage to the power storage devices 13a, 13b, respectively. Specifically, the main conversion device 2a included in the drive control apparatus 2 includes the step-down circuit 41a that lowers the voltage of the DC power supplied from the converter 11a, and supplies the DC power with the lowered voltage to the power storage device 13a. The main conversion device 2b included in the drive control apparatus 2 includes the step-down circuit 41b that lowers the voltage of the DC power supplied from the converter 11b and supplies the DC power with the lowered voltage to the power storage device 13b.

As in Embodiment 1, even if the output voltage of the converters 11a, 11b rises to a value appropriate for the first inverters 12a, 12b and the second inverters 14a, 14b immediately after the start of internal combustion engines 91a, 91b, the step-down circuits 41a, 41b supply to the power storage devices 13a, 13b the DC power with the lowered voltage. Therefore, the power storage devices 13a, 13b do not need to be large power storage devices that can withstand high voltages. This configuration allows to suppress increasing a size of the drive control apparatus 2.

In the drive control apparatus 2, when either the internal combustion engine 91a or the internal combustion engine 91b is started due to one of the power storage devices 13a, 13b discharged, one of the first inverters 12a, 12b may convert the AC power supplied from the other of the first inverters 12a, 12b into DC power, and supplies the resulting DC power to the power storage device 13a or the power storage device 13b via the step-down circuit 41a or the step-down circuit 41b.

The operation of charging of the power storage devices 13a, 13b of the drive control apparatus 1 is not limited to the foregoing examples. In one example, the drive control apparatus 1 may output the determination result of the start determiner 34 to a display device when the start command signal S1 is switched from the L level to the H level, and then, after the elapse of a charging period, the start determiner 34 determines that the intermediate link voltage V1 or the intermediate link voltage V2 is less than the start voltage. The charging period is a time for charging the capacitor of the converters 11a, 11b. The display device is installed in the driver cab.

After outputting the determination result to the display device installed in the driver cab, the drive control apparatus 1 may charge the discharged power storage device 13a or power storage device 13b as in Embodiment 1 upon an operator operating a charging switch for instructing charging of the discharged power storage device 13a or power storage device 13b.

Upon completion of charging of the power storage device 13a or power storage device 13b that is discharged at the point of time at which the start command signal S1 is switched from the L level to the H level, the drive control apparatus 1 may output notification indicating that the charging has completed to the display device installed in the driver cab, and may prompt the operator to stop and restart the drive control apparatus 1. Since the power storage device 13a or power storage device 13b that has discharged is charged, in other words, since both of the power storage devices 13a, 13b are sufficiently charged, when the drive control apparatus 1 is restarted, both of the internal combustion engines 91a, 91b are started.

In another example, immediately after the start of the internal combustion engines 91a, 91b, the power storage devices 13a, 13b may be charged by maintaining the output voltage of the converters 11a, 11b at a value appropriate for the power storage devices 13a, 13b that is lower than a value appropriate for the first inverters 12a, 12b and the second inverters 14a, 14b. In this case, upon the determination result of the charging determiner 35 indicating that charging of the power storage devices 13a, 13b is completed, the power conversion controllers 33 included in the controllers 15a, 15b may increase the output voltage of the converters 11a, 11b to a value appropriate for the first inverters 12a, 12b and the second inverters 14a, 14b to cause the first inverters 12a, 12b and the second inverters 14a, 14b to operate.

The operation after the start of the internal combustion engines 91a, 91b is not limited to the foregoing examples. When the first inverters 12a, 12b operate in synchronization with each other, the first contactor controllers 31 included in the controllers 15a, 15b may close the inverter contactors 19a, 19b immediately after the start of the internal combustion engines 91a, 91b.

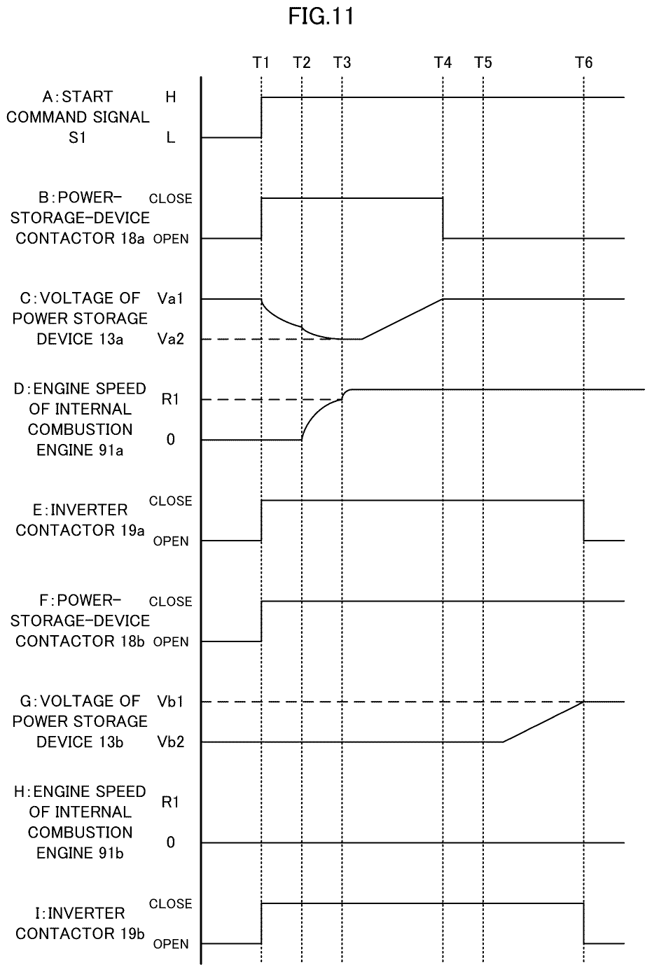

The first contactor controllers 31 may close the inverter contactors 19a, 19b at the start of the internal combustion engine 91a, 91b, and open the inverter contactors 19a, 19b upon the start of both of the internal combustion engines 91a, 91b. Specifically, as illustrated in FIG. 11, the first contactor controllers 31 included in the controllers 15a, 15b may close the inverter contactors 19a, 19b at the time T1 when the start command signal is switched from the L level to the H level. The subsequent operation of the drive control apparatus 1 is similar to the operation of the drive control apparatus 1 according to Embodiment 1 illustrated in FIG. 6.

When only the internal combustion engine 91a is started, upon acquiring the operation command signal S2 indicating the powering command, the power conversion controller 33 included in the controller 15a may control the switching elements of the second inverter 14a regardless of the determination result acquired from the start determiner 34 included in the controller 15b. As a result, the second inverter 14a converts the DC power into AC power, and supplies the resulting AC power to the main motor 93a. The main motor 93a receiving the AC power generates propulsion of the railway vehicle. This enables running of the railway vehicle while only the internal combustion engine 91a is started.

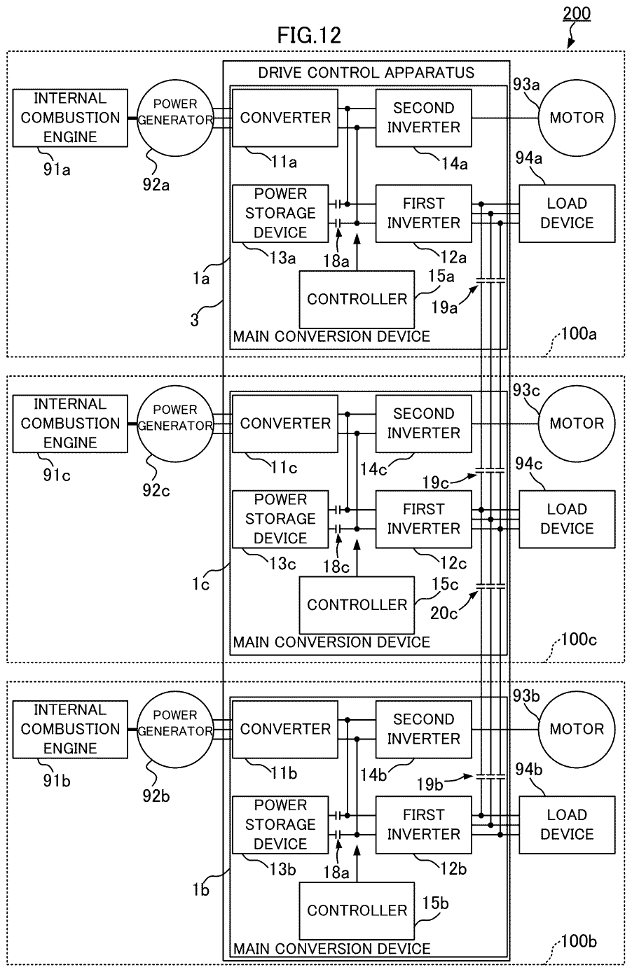

The number of internal combustion engines and the number of main conversion devices installed in one railway vehicle are not limited to the foregoing examples, but can be any number as it is each equal to or greater than two. A railway vehicle driving apparatus 200 to drive a railway vehicle including vehicles 100a, 100b, 100c is illustrated in FIG. 12. The railway vehicle driving apparatus 200 includes, in addition to the configuration of the railway vehicle driving apparatus 100, an internal combustion engine 91c that is a power source, a power generator 92c driven by the internal combustion engine 91c to generate AC power, a main motor 93c to rotate with the AC power to generate propulsion of the railway vehicle, and a load device 94c to operate with the AC power.

A drive control apparatus 3 included in the railway vehicle driving apparatus 200 includes three main conversion devices 1a, 1b, 1c. The configuration of the main conversion devices 1a, 1b is similar to the configuration as in Embodiment 1. The main conversion device lc includes an inverter contactor 20c in addition to a configuration similar to the configuration of the main conversion devices 1a, 1b. Specifically, the main conversion device 1c includes a converter 11c, a first inverter 12c, a second inverter 14c, and a power storage device 13c. The converter 11c converts AC power supplied from the power generator 92c into DC power, and outputs the resulting DC power. The first inverter 12c converts the DC power supplied from the converter 11c into AC power, and outputs the resulting AC power. The second inverter 14c converts the DC power supplied from the converter 11c into AC power, and supplies the resulting AC power to the main motor 93c. The power storage device 13c is connected to the converter 11c, the first inverter 12c, and the second inverter 14c. The main conversion device 1c includes power-storage-device contactors 18c and inverter contactors 19c, 20c. The power-storage-device contactors 18c switch electrical connection between (i) the power storage device 13c and (ii) the converter 11c, the first inverter 12c, and the second inverter 14c. The main conversion device 1c includes a controller 15c to control the converter 11c, the first inverter 12c, the second inverter 14c, the power-storage-device contactors 18c, and the inverter contactors 19c.

The main conversion device 1c is installed in the vehicle 100c. In FIG. 12, the primary terminals that are DC-side terminals of the first inverters 12a, 12b, 12c and the secondary terminals that are AC-side terminals of the first inverters 12a, 12b, 12c, the transformer and the AC capacitor connected to the secondary terminals of the first inverters 12a, 12b, 12c are omitted to simplify illustration.

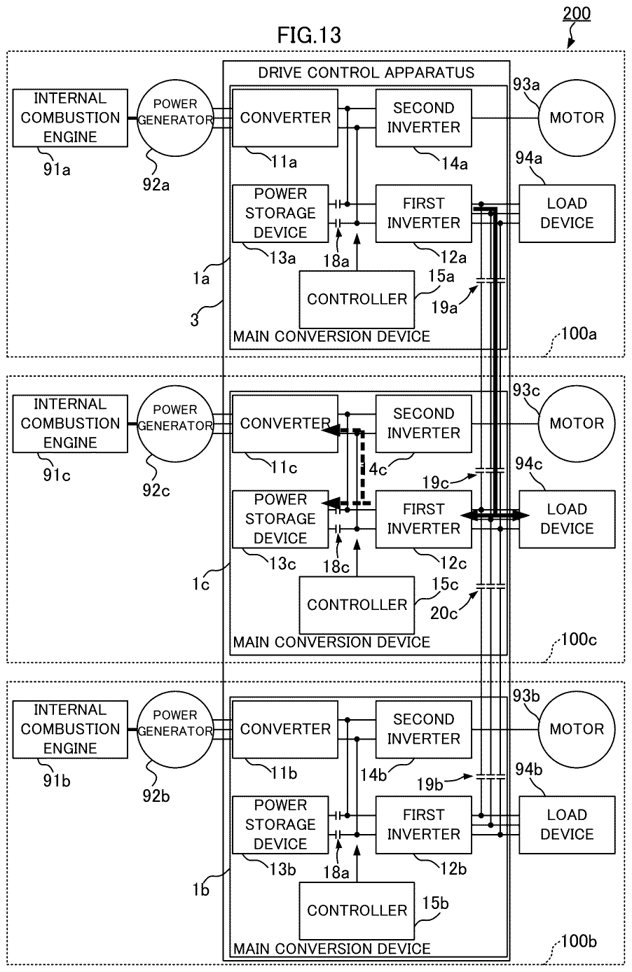

In a state in which the power storage device 13c is discharged, as one example, the first inverter 12a supplies AC power via the inverter contactors 19a, 19c to the first inverter 12c as indicated by solid arrows in FIG. 13. The first inverter 12c converts the AC power supplied from the first inverter 12a into DC power, and outputs the resulting DC power. As indicated by dotted-line arrows in FIG. 13, the first inverter 12c supplies the DC power to the converter 11c and the power storage device 13c. This allows the power storage device 13c to store sufficient power for starting the internal combustion engine 91c next when charging of the power storage device 13c is performed.

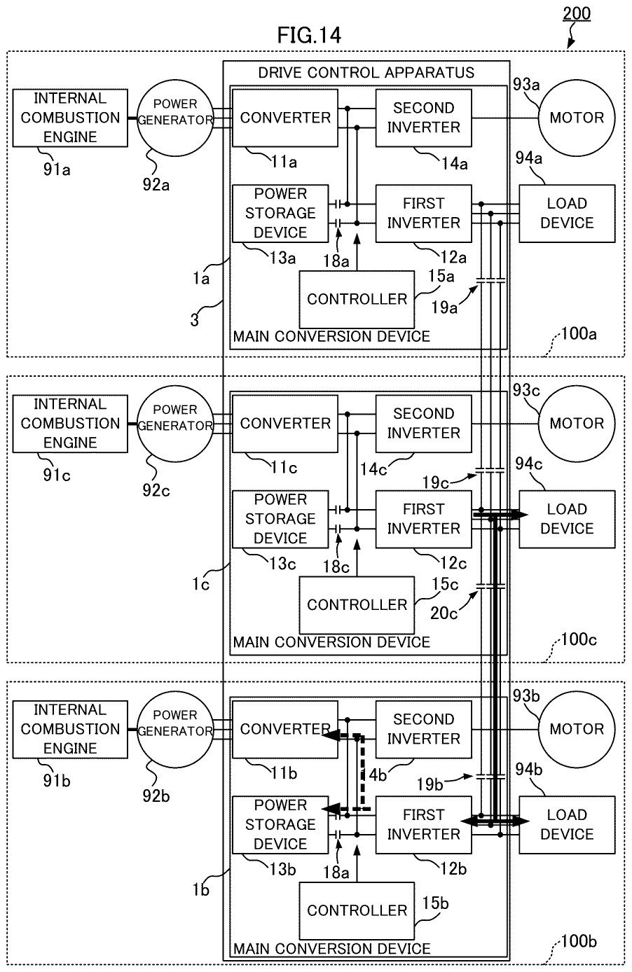

In a state in which the power storage device 13b is discharged, as one example, the first inverter 12c supplies AC power via the inverter contactors 20c, 19b to the first inverter 12b as indicated by solid arrows in FIG. 14. The first inverter 12b converts the AC power supplied from the first inverter 12c into DC power, and outputs the resulting DC power. As indicated by dotted-line arrows in FIG. 14, the first inverter 12b supplies the DC power to the converter 11b and the power storage device 13b. This allows the power storage device 13b to store sufficient power for starting the internal combustion engine 91b next when charging of the power storage device 13b is performed.

Similarly to Embodiment 2, the drive control apparatus 1 may start the unstarted internal combustion engine 91a, internal combustion engine 91b, or internal combustion engine 91c, and then charge the discharged power storage device 13a, power storage device 13b, or power storage device 13c.

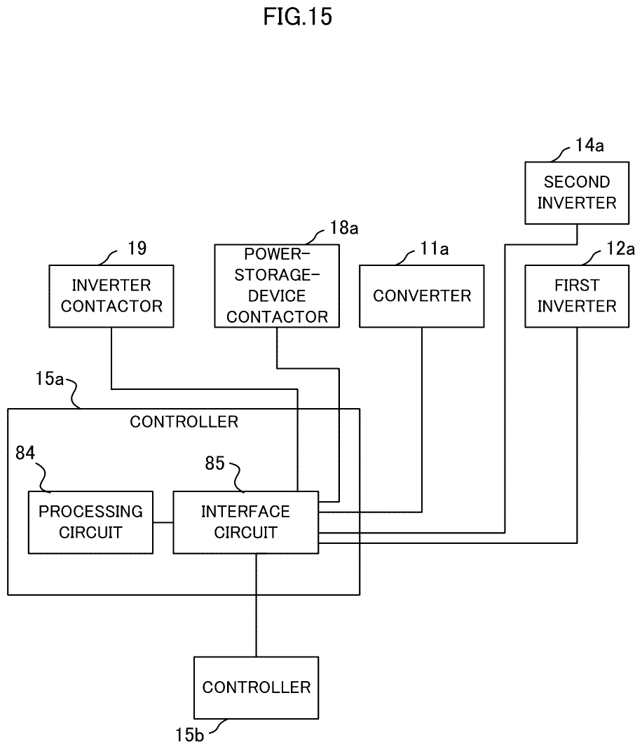

The hardware configurations of the controllers 15a, 15b, 15c are not limited to the foregoing examples. As one example, a modified example of the hardware configuration of the controller 15a is illustrated in FIG. 15. The controller 15a may be achieved by a processing circuit 84, as illustrated in FIG. 15. The processing circuit 84 is connected through an interface circuit 85 to the controller 15b, the converter 11a, the first inverter 12a, the second inverter 14a, the power-storage-device contactors 18a, and the inverter contactors 19a.

In a case where the processing circuit 84 is dedicated hardware, the processing circuit 84 includes, for example, a single circuit, a composite circuit, a processor, an application specific integrated circuit (ASIC), a field programmable gate array (FPGA), or a combination thereof. Each component of the controllers 15a, 15b may be implemented by an individual processing circuit 84 or a shared processing circuit 84.

A part of each function of the controllers 15a, 15b, 15c may be implemented by dedicated hardware and another part thereof may be implemented by software or firmware. For example, in the controller 15a included in the drive control apparatus 1 according to Embodiment 1, the first contactor controller 31, the second contactor controller 32, and the power conversion controller 33 may be implemented by the processing circuit 84 illustrated in FIG. 15. The start determiner 34 and the charging determiner 35 may be implemented by the processor 81 illustrated in FIG. 4 reading and executing the program stored in the memory 82.

At least a part of the controllers 15a, 15b, 15c may be implemented as a function of a train information management system.

The drive control apparatuses 1, 2, 3 may be installed in any moving body powered by a plurality of internal combustion engines, such as a trolley bus, other than railway vehicles.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1, 2, 3 Drive control apparatus
1a, 1b, 1c, 2a, 2b Main conversion device
11a, 11b, 11c Converter
12a, 12b, 12c First inverter
13a, 13b, 13c Power storage device
14a, 14b, 14c Second inverter
15a, 15b, 15c Controller
16a, 16b Transformer
17a, 17b AC capacitor
18a, 18b, 18c Power-storage-device contactor
19a, 19b, 19c, 20c Inverter contactor
21a, 21b, 22a, 22b Primary terminal
23a, 23b, 24a, 24b, 25a, 25b Secondary terminal
31 First contactor controller
32 Second contactor controller
33 Power conversion controller
34 Start determiner
35 Charging determiner
41a, 41b Step-down circuit
80 Bus
81 Processor
82 Memory
83 Interface
84 Processing circuit
85 Interface circuit
91a, 91b, 91c Internal combustion engine
92a, 92b, 92c Power generator
93a, 93b, 93c Main motor
94a, 94b, 94c Load device
100, 200 Railway vehicle driving apparatus
100a, 100b, 100c Vehicle
C1 Capacitor
D1, D2, D3, D4, D5, D6 Freewheeling diode
S1 Start command signal
S2 Operation command signal
SW1, SW2, SW3, SW4, SW5, SW6 Switching element

1. A drive control apparatus for controlling driving of a railway vehicle that uses internal combustion engines as a power source, the drive control apparatus comprising:
converters provided for respective power generators and being capable of performing bidirectional power conversion between AC power and DC power, the power generators being provided for the respective internal combustion engines and being driven by the respective internal combustion engines to generate AC power;
first inverters provided for the respective converters, each having primary terminals and secondary terminals, and being capable of performing bidirectional power conversion between DC power and AC power, the primary terminals being connected to the converter, the secondary terminals being connected to a load device, the load device operating with AC power; and
power storage devices provided for the respective converters and each connected to the corresponding converter and the primary terminals of the corresponding first inverter, each power storage device being charged with DC power output by the converter or the first inverter, and storing power for starting the internal combustion engine, wherein
the secondary terminals of the first inverters are connected to each other,
at a start of the internal combustion engines, each of the converters converts DC power into AC power, and supplies the AC power resulting from the conversion to the power generator, and
when only part of the internal combustion engines is started, one first inverter, of the first inverters, connected via the power generator and the converter to an unstarted internal combustion engine, of the internal combustion engines, receives AC power from another first inverter, of the first inverters, connected via the converter to the power generator driven by the started internal combustion engine, converts the received AC power into DC power, and supplies the DC power resulting from the conversion to at least one of the converter or the power storage device.

2. The drive control apparatus according to claim 1, further comprising:
at least one inverter contactor to electrically connect or disconnect secondary terminals of a first inverter, of the first inverters, to or from secondary terminals of another first inverter, of the first inverters; and
first contactor controlling circuitry to close or open the at least one inverter contactor.

3. The drive control apparatus according to claim 2, wherein
the first contactor controlling circuitry closes each of the at least one inverter contactor at the start of the internal combustion engines.

4. The drive control apparatus according to claim 2, wherein
when only part of the internal combustion engines is started, the first contactor controlling circuitry electrically connects, by closing the at least one inverter contactor, the secondary terminals of the one first inverter connected to the unstarted internal combustion engine via the power generator and the converter, to the secondary terminals of the another first inverter connected via the converter to the power generator driven by the started internal combustion engine.

5. The drive control apparatus according to claim 4, wherein
when the first contactor controlling circuitry closes the at least one inverter contactor while only part of the internal combustion engines is started, the one first inverter connected to the unstarted internal combustion engine via the power generator and the converter receives AC power from the another first inverter connected via the converter to the power generator driven by the started internal combustion engine, converts the AC power into DC power, and supplies the DC power resulting from the conversion to the power storage device connected to the primary terminals of the one first inverter, and the power storage device is charged with the DC power supplied from the one first inverter.

6. The drive control apparatus according to claim 4, wherein
when the first contactor controlling circuitry closes the at least one inverter contactor while only part of the internal combustion engines is started, the one first inverter connected to the unstarted internal combustion engine via the power generator and the converter receives AC power from the another first inverter connected via the converter to the power generator driven by the started internal combustion engine, converts the AC power into DC power, and supplies the DC power resulting from the conversion to the converter connected to the primary terminals of the one first inverter, and the converter converts the DC power supplied from the one first inverter into AC power, and supplies the AC power resulting from the conversion to the power generator connected to the converter.

7. The drive control apparatus according to claim 4, further comprising:
power-storage-device contactors provided for the respective power storage devices, each power-storage-device contactor electrically connecting the power storage device to the converter and the primary terminals of the first inverter or electrically disconnecting the power storage device from the converter and the primary terminals of the first inverter; and
second contactor controlling circuitry to close or open the power-storage-device contactors, wherein
the second contactor controlling circuitry closes each of the power-storage-device contactors at the start of the internal combustion engines, and, when the internal combustion engines are started and each power storage device is charged with the DC power supplied from the converter connected to the power generator driven by the started internal combustion engine, the second contactor controlling circuitry opens the power-storage-device contactors connected to the respective power storage devices charged.

8-13. (canceled)

14. The drive control apparatus according to claim 5, further comprising:
power-storage-device contactors provided for the respective power storage devices, each power-storage-device contactor electrically connecting the power storage device to the converter and the primary terminals of the first inverter or electrically disconnecting the power storage device from the converter and the primary terminals of the first inverter; and
second contactor controlling circuitry to close or open the power-storage-device contactors, wherein
the second contactor controlling circuitry closes each of the power-storage-device contactors at the start of the internal combustion engines, and, when the internal combustion engines are started and each power storage device is charged with the DC power supplied from the converter connected to the power generator driven by the started internal combustion engine, the second contactor controlling circuitry opens the power-storage-device contactors connected to the respective power storage devices charged.

15. The drive control apparatus according to claim 7, wherein
at the start of the internal combustion engines, when a voltage of the DC power supplied from the power storage device to the converter is less than a start voltage after the second contactor controlling circuitry closes each of the power-storage-device contactors, the second contactor controlling circuitry opens the power-storage-device contactor connected to the power storage device, the start voltage being a voltage to start the internal combustion engine.

16. The drive control apparatus according to claim 14, wherein
at the start of the internal combustion engines, when a voltage of the DC power supplied from the power storage device to the converter is less than a start voltage after the second contactor controlling circuitry closes each of the power-storage-device contactors, the second contactor controlling circuitry opens the power-storage-device contactor connected to the power storage device, the start voltage being a voltage to start the internal combustion engine.

17. The drive control apparatus according to claim 1, wherein
the first inverters each include a rectifier circuit to rectify AC power from another first inverter to convert the AC power into DC power, and supply the DC power resulting from the conversion to at least one of the converter or the power storage device.

18. The drive control apparatus according to claim 2, wherein
the first inverters each include a rectifier circuit to rectify AC power from another first inverter to convert the AC power into DC power, and supply the DC power resulting from the conversion to at least one of the converter or the power storage device.

19. The drive control apparatus according to claim 1, further comprising:
step-down circuits provided for the respective converters, each connected to the converter and the primary terminals of the first inverter, and each lowering a voltage of the DC power supplied from the converter or the first inverter that is connected to the step-down circuit, thereby supplying the DC power with a lowered voltage to the power storage device, wherein
upon the start of the internal combustion engine, the converter converts the AC power output by the power generator driven by the started internal combustion engine into DC power, supplies the DC power resulting from the conversion to the first inverter, and supplies the DC power resulting from the conversion to the power storage device via the step-down circuit.

20. The drive control apparatus according to claim 2, further comprising:
step-down circuits provided for the respective converters, each connected to the converter and the primary terminals of the first inverter, and each lowering a voltage of the DC power supplied from the converter or the first inverter that is connected to the step-down circuit, thereby supplying the DC power with a lowered voltage to the power storage device, wherein
upon the start of the internal combustion engine, the converter converts the AC power output by the power generator driven by the started internal combustion engine into DC power, supplies the DC power resulting from the conversion to the first inverter, and supplies the DC power resulting from the conversion to the power storage device via the step-down circuit.

21. The drive control apparatus according to claim 19, wherein
when only part of the internal combustion engines is started, the one first inverter connected via the power generator and the converter to the unstarted internal combustion engine receives AC power from the another first inverter connected via the converter to the power generator driven by the started internal combustion engine, converts the AC power into DC power, and supplies the DC power resulting from the conversion via the step-down circuit to the power storage device.

22. The drive control apparatus according to claim 20, wherein
when only part of the internal combustion engines is started, the one first inverter connected via the power generator and the converter to the unstarted internal combustion engine receives AC power from the another first inverter connected via the converter to the power generator driven by the started internal combustion engine, converts the AC power into DC power, and supplies the DC power resulting from the conversion via the step-down circuit to the power storage device.

23. The drive control apparatus according to claim 1, further comprising:
power conversion controlling circuitry to control the converter and the first inverter, wherein
when only part of the internal combustion engines is started,
by the power conversion controlling circuitry controlling the converter that receives the AC power from the power generator driven by the started internal combustion engine, the converter converts the AC power into DC power, and supplies the DC power resulting from the conversion to the first inverter, and
by the power conversion controlling circuitry controlling the first inverter, the first inverter converts the supplied DC power into AC power to be supplied to the load device, supplies the AC power resulting from the conversion to the load device and the first inverter at a secondary side connected via the power generator and the converter to the unstarted internal combustion engine.

24. The drive control apparatus according to claim 2, further comprising:
power conversion controlling circuitry to control the converter and the first inverter, wherein
when only part of the internal combustion engines is started,
by the power conversion controlling circuitry controlling the converter that receives the AC power from the power generator driven by the started internal combustion engine, the converter converts the AC power into DC power, and supplies the DC power resulting from the conversion to the first inverter, and
by the power conversion controlling circuitry controlling the first inverter, the first inverter converts the supplied DC power into AC power to be supplied to the load device, supplies the AC power resulting from the conversion to the load device and the first inverter at a secondary side connected via the power generator and the converter to the unstarted internal combustion engine.

25. The drive control apparatus according to claim 23, further comprising:
second inverters provided for the respective converters, the second inverters each, upon receiving DC power from the converter, converting the DC power into AC power for supply to a main motor, and supplying the AC power resulting from the conversion to the main motor, wherein
the power conversion controlling circuitry controls the converter, the first inverter, and the second inverter, and
when only part of the internal combustion engines is started,
the power conversion controlling circuitry controls the first inverter while stopping the second inverter.

26. The drive control apparatus according to claim 24, further comprising:
second inverters provided for the respective converters, the second inverters each, upon receiving DC power from the converter, converting the DC power into AC power for supply to a main motor, and supplying the AC power resulting from the conversion to the main motor, wherein
the power conversion controlling circuitry controls the converter, the first inverter, and the second inverter, and
when only part of the internal combustion engines is started,
the power conversion controlling circuitry controls the first inverter while stopping the second inverter.
